(19) United States
(12) Patent Application Publication
(10) Pub. No.: US 2026/0155652 A1
(43) Pub. Date: Jun. 4, 2026

(54) METHOD FOR GENERATING INSTALLED CAPACITY OF POWER SYSTEM, DEVICE, MEDIUM, AND PRODUCT

(71) Applicants: North China Electric Power University, Beijing (CN); NARI Technology Development Co., Ltd., Nanjing City (CN)

(72) Inventors: Nian LIU, Beijing (CN); Kai JIANG, Beijing (CN); Yurou JIANG, Beijing (CN); Jie HUANG, Nanjing City (CN); Zhen WANG, Nanjing City (CN); Lei WANG, Beijing (CN)

(21) Appl. No.: 19/401,972

(22) Filed: Nov. 26, 2025

(30) Foreign Application Priority Data
Dec. 3, 2024 (CN) 202411755154.1

(51) Int. Cl. H02J 3/00; H02J 3/28; H02J 3/38

(52) U.S. Cl. CPC H02J 3/004; H02J 3/28; H02J 3/381; H02J 2101/24; H02J 2101/28; H02J 2103/30

(57) ABSTRACT

Provided are a method for generating an installed capacity of a power system, a device, a medium, and a product. The method includes: acquiring an expected upper limit of a one-time investment coefficient and an expected lower limit of a new energy consumption rate for a target power system; determining an installed capacity of the target power system by using a power system installed capacity generation model. The installed capacity is defined by an installed capacity upper bound and an installed capacity lower bound, and the power system installed capacity generation model is obtained by training a Convolutional Neural Network (CNN)-Bidirectional Long Short-Term Memory (BiLSTM)-Bidirectional Gated Recurrent Unit (BiGRU) neural network model using a training dataset. The training dataset is established using a multi-objective coronavirus disease optimization algorithm and a wave search algorithm. The CNN-BiLSTM-BiGRU neural network model includes a CNN, a BiLSTM neural network, and a BiGRU connected sequentially.

### CROSS REFERENCE TO RELATED APPLICATION

This patent application claims the benefit and priority of Chinese Patent Application No. 202411755154.1, filed with the China National Intellectual Property Administration on Dec. 3, 2024, the disclosure of which is incorporated by reference herein in its entirety as part of the present application.

### TECHNICAL FIELD

The present disclosure relates to the field of installed capacity generation for power systems, and in particular, to a method for generating an installed capacity of a power system, a device, a medium, and a product.

### BACKGROUND

With the deepening advancement of the global energy transition, the proportion of new energy generation is increasing year by year. Due to the randomness and volatility of new energy sources such as wind and solar energy, current power systems face the problem of difficulty in balancing a high new energy consumption rate with the safe and stable operation of the power systems. The new energy consumption rate has also become an important assessment indicator for the current power systems. A reasonable power source structure arrangement on the generation side is a key factor affecting the new energy consumption rate. Excessive capacity construction of new energy units or insufficient energy storage configuration will lead to significant curtailment of new energy. Even though appropriate operational dispatch strategies can promote the utilization of some new energy, the improvement of the new energy consumption rate is limited by system operational safety requirements. Meanwhile, existing capacity design methods have difficulty in comprehensively describing the multi-dimensional attributes of power system capacity, and lack intuitive decision support tools when dealing with the development trends of power generation capacity. A power system installed capacity established based on domain theory can clearly display the capacity boundaries of the power system, providing capacity boundary support for power system generation development from a long-term perspective.

### SUMMARY

An objective of the present disclosure is to provide a method for generating an installed capacity of a power system, a device, a medium, and a product, to improve the accuracy of generating a power system installed capacity.

To achieve the above objective, the present disclosure provides the following technical solutions.

According to a first aspect, the present disclosure provides a method for generating an installed capacity of a power system, including:
acquiring an expected upper limit of a one-time investment coefficient and an expected lower limit of a new energy consumption rate for a target power system; and
determining an installed capacity of the target power system according to the expected upper limit of the one-time investment coefficient and the expected lower limit of the new energy consumption rate by using a power system installed capacity generation model, where the installed capacity is defined by an installed capacity upper bound and an installed capacity lower bound; the power system installed capacity generation model is obtained by training a Convolutional Neural Network (CNN)-Bidirectional Long Short-Term Memory (BiLSTM)-Bidirectional Gated Recurrent Unit (BiGRU) neural network model using a training dataset; the training dataset is established using a multi-objective coronavirus disease optimization algorithm and a wave search algorithm; the training dataset includes an upper limit of the one-time investment coefficient, a lower limit of a new energy consumption rate, and a corresponding installed capacity label for each stage of a training power system; and the CNN-BiLSTM-BiGRU neural network model includes a CNN, a BiLSTM neural network, and a BiGRU connected sequentially.

Optionally, the training the CNN-BiLSTM-BiGRU neural network model using the training dataset specifically includes:
constructing the training dataset;
inputting the upper limit of the one-time investment coefficient and the lower limit of the new energy consumption rate for each stage of the training power system into a current CNN-BiLSTM-BiGRU neural network model to obtain a predicted value of the installed capacity upper bound and a predicted value of the installed capacity lower bound;
determining a loss function value according to the predicted value of the installed capacity upper bound, the predicted value of the installed capacity lower bound, and the corresponding installed capacity label;
determining whether a training termination condition is satisfied, where the training termination condition is that a maximum number of iterations is reached or that the loss function value is less than a preset value;
if yes, terminating the training, and using the current CNN-BiLSTM-BiGRU neural network model as the power system installed capacity generation model; or
if not, adjusting model parameters of the current CNN-BiLSTM-BiGRU neural network model according to the loss function value, and returning to the step of “inputting the upper limit of the one-time investment coefficient and the lower limit of the new energy consumption rate for each stage of the training power system into the current CNN-BiLSTM-BiGRU neural network model to obtain the predicted value of the installed capacity upper bound and the predicted value of the installed capacity lower bound”.

Optionally, the constructing the training dataset specifically includes:
generating the upper limit of the one-time investment coefficient and the lower limit of the new energy consumption rate for each stage of the training power system by using a random function;
generating an initial installed capacity of the training power system by using the multi-objective coronavirus disease optimization algorithm; and determining, based on the initial installed capacity, the installed capacity label corresponding to the upper limit of the one-time investment coefficient and the lower limit of the new energy consumption rate for each stage of the training power system by using the wave search algorithm, to obtain the training dataset.

Optionally, the generating the initial installed capacity of the training power system by using the multi-objective coronavirus disease optimization algorithm specifically includes:
establishing a multi-objective optimization model, where the multi-objective optimization model takes minimizing a total coefficient and maximizing the new energy consumption rate as objective functions, and takes unit capacity constraints, unit commitment constraints, and clean low-carbon driving constraints as constraint conditions;
solving the multi-objective optimization model by using the multi-objective coronavirus disease optimization algorithm to determine an installed capacity optimal solution set; and
determining the initial installed capacity of the training power system according to the installed capacity optimal solution set, where an upper bound of the initial installed capacity is a maximum power source capacity value in the installed capacity optimal solution set, and a lower bound of the initial installed capacity is a minimum power source capacity value in the installed capacity optimal solution set.

Optionally, the objective functions are:

$$\{ \begin{matrix}min {F}^{a} = \frac{1}{{T}_{a}} {{\sum }^{}}_{∀ k , ∀ n} [ {a}_{n}^{k} ( {P}_{n}^{k} - {P}_{n - 1}^{k} ) + {m}_{n}^{k} {P}_{n}^{k} ] + \\ {{\sum }^{}}_{∀ n , ∀ s , ∀ t} {τ}_{s} {e}_{n}^{es} ( {p}_{n , s , t}^{es , c} + {p}_{n , s , t}^{es , d} ) Δ t + {{\sum }^{}}_{∀ n , ∀ s , ∀ t} {τ}_{s} {e}_{n}^{g} {p}_{n , s , t}^{g} Δ t + \\ {{\sum }^{}}_{∀ n , ∀ s , ∀ t} {τ}_{s} {e}_{n}^{cur} {p}_{n , s , t}^{cur} Δ t \\ min {G}^{a} = - \frac{1}{{N}_{r}} {{\sum }^{}}_{∀ n} \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )}\end{matrix}$$

where F^{a} is a total cost; Tₐ is the number of days in a current stage;

$${a}_{n}^{k}$$

is an investment cost per unit of capacity of power generation equipment in an n-th stage;

$${P}_{n}^{k}$$

is an installed capacity of the power generation equipment in the n-th stage;

$${P}_{n - 1}^{k}$$

is an installed capacity of the power generation equipment in an (n−1)-th stage;

$${m}_{n}^{k}$$

is a maintenance cost per unit of capacity of the power generation equipment in the n-th stage; τₛ is a weight coefficient of an s-th scenario;

$${e}_{n}^{es}$$

is an operating cost per unit of power of electrochemical energy storage equipment in the n-th stage;

$${p}_{n , s , t}^{es , c}$$

is a charging power of the electrochemical energy storage equipment in the n-th stage, s-th scenario, and a t-th time period;

$${p}_{n , s , t}^{es , d}$$

is a discharging power of the electrochemical energy storage equipment in the n-th stage, s-th scenario, and t-th time period; Δt is a time interval;

$${e}_{n}^{g}$$

is an operating cost per unit of electricity of thermal power in the n-th stage;

$${p}_{n , s , t}^{g}$$

is an actual output of thermal power in the n-th stage, s-th scenario, and t-th time period;

$${e}_{n}^{cur}$$

is a penalty cost per unit of electricity for load shedding;

$${p}_{n , s , t}^{cur}$$

is an actual load shedding in the n-th stage, s-th scenario, and t-th time period; G^{a} is a new energy consumption rate; Nᵣ is the number of stages for power generation capacity decision-making;

$${p}_{n , s , t}^{w}$$

is an actual output of wind power in the n-th stage, s-th scenario, and t-th time period;

$${p}_{n , s , t}^{p}$$

is an actual output of photovoltaic power in the n-th stage, s-th scenario, and t-th time period;

$${P}_{n}^{w}$$

is an installed capacity of wind power in the n-th stage;

$${P}_{n}^{p}$$

is an installed capacity of photovoltaic power in the n-th stage;

$${c}_{n , s , t}^{w}$$

is a predicted capacity factor of wind power in the n-th stage, s-th scenario, and t-th time period; and

$${c}_{n , s , t}^{p}$$

is a predicted capacity factor of photovoltaic power in the n-th stage, s-th scenario, and t-th time period.

Optionally, the unit capacity constraints are:

$$\{ \begin{matrix}{B}_{n}^{k} \leq {P}_{n}^{k} \leq {A}_{n}^{k} , ∀ n , ∀ k \\ {P}_{n}^{k} \leq {P}_{n + 1}^{k} , ∀ n \\ {\sum }_{k ∈ \{ w , p , g , e , s \}} {a}_{n}^{k} ( {P}_{n}^{k} - {P}_{n - 1}^{k} ) \leq {F}_{n}^{pre} , ∀ n\end{matrix}$$

where

$${P}_{n}^{k}$$

is an installed capacity of power generation equipment in an n-th stage;

$${P}_{n + 1}^{k}$$

is an installed capacity of the power generation equipment in an (n+1)-th stage;

$${B}_{n}^{k}$$

is a lower limit of the installed capacity in the n-th stage;

$${A}_{n}^{k}$$

is an upper limit of the installed capacity in the n-th stage;

$${a}_{n}^{k}$$

is an investment cost per unit of capacity of the power generation equipment in the n-th stage;

$${P}_{n - 1}^{k}$$

is an installed capacity of the power generation equipment in an (n−1)-th stage; and

$${F}_{n}^{pre}$$

is an expected upper limit of the one-time investment coefficient in the n-th stage;
the unit commitment constraints include wind and photovoltaic power operation constraints, thermal power operation constraints, electrochemical energy storage equipment operation constraints, and spinning reserve capacity constraints;
the wind and photovoltaic power operation constraints are:

$$\{ \begin{matrix}0 \leq {p}_{n , s , t}^{w} \leq {c}_{n , s , t}^{w} {P}_{n}^{w} , & ∀ n , ∀ s , ∀ t \\ 0 \leq {p}_{n , s , t}^{p} \leq {c}_{n , s , t}^{p} {P}_{n}^{p} , & ∀ n , ∀ s , ∀ t\end{matrix} ;$$

where

$${p}_{n , s , t}^{w}$$

is an actual output of wind power in the n-th stage, an s-th scenario, and a t-th time period;

$${p}_{n , s , t}^{p}$$

is an actual output of photovoltaic power in the n-th stage, s-th scenario, and t-th time period;

$${P}_{n}^{w}$$

is an installed capacity of wind power in the n-th stage;

$${P}_{n}^{p}$$

is an installed capacity of photovoltaic power in the n-th stage;

$${c}_{n , s , t}^{w}$$

is a predicted capacity factor of wind power in the n-th stage, s-th scenario, and t-th time period; and

$${c}_{n , s , t}^{p}$$

is a predicted capacity factor of photovoltaic power in the n-th stage, s-th scenario, and t-th time period;
the thermal power operation constraints are:

$$\{ \begin{matrix}{p}_{n , s , t}^{g} - {p}_{n , s , t - 1}^{g} \leq {β}_{up}^{g} {b}_{n , s , t}^{g} , & ∀ n , ∀ s , ∀ t \\ {p}_{n , s , t - 1}^{g} - {p}_{n , s , t}^{g} \leq {β}_{down}^{g} {b}_{n , s , t}^{g} , & ∀ n , ∀ s , ∀ t \\ {α}_{min}^{g} {b}_{n , s , t}^{g} \leq {p}_{n , s , t}^{g} \leq {α}_{max}^{g} {b}_{n , s , t}^{g} \leq {P}_{n}^{g} , & ∀ n , ∀ s , ∀ t \\ {b}_{n , s , t}^{g} = {\sum }_{j = 1}^{{J}^{g}} {u}_{n , s , t , j}^{g} {P}_{n , j}^{g} & \end{matrix}$$

where

$${p}_{n , s , t}^{g}$$

is an actual output of thermal power in the n-th stage, s-th scenario, and t-th time period;

$${p}_{n , s , t - 1}^{g}$$

is an actual output of thermal power in the n-th stage, s-th scenario, and a (t−1)-th time period;

$${β}_{up}^{g}$$

is a ramping-up power coefficient of thermal power;

$${b}_{n , s , t}^{g}$$

is a grid-connected capacity of thermal power in the n-th stage, s-th scenario, and t-th time period;

$${β}_{down}^{g}$$

is a ramping-down power coefficient of thermal power;

$${α}_{min}^{g}$$

is a minimum technical output coefficient of thermal power;

$${α}_{max}^{g}$$

is a maximum technical output coefficient of thermal power;

$${P}_{n}^{g}$$

is a total installed capacity of thermal power;

$${P}_{n , j}^{g}$$

is an installed capacity of a j-th thermal power unit in the n-th stage;

$${u}_{n , s , t , j}^{g}$$

is an on/off status of the j-th thermal power unit in the n-th stage, s-th scenario, and t-th time period;
the electrochemical energy storage equipment operation constraints are:

$$\{ \begin{matrix}{p}_{n , s , t}^{s} = {p}_{n , s , t}^{es , d} - {p}_{n , s , t}^{es , c} \\ 0 \leq {p}_{n , s , t}^{es , c} , {p}_{n , s , t}^{es , d} \leq {P}_{n}^{es} \\ {p}_{n , s , t}^{es , c} \times {p}_{n , s , t}^{es , d} = 0 \\ {SoC}_{n , s , t}^{es} = {SoC}_{n , s , t - 1}^{es} + \frac{( {η}_{n}^{es , c} {p}_{n , s , t}^{es , c} - {p}_{n , s , t}^{es , d} / {η}_{n}^{es , d} ) Δ t}{{E}_{n}^{es}} , ∀ n , ∀ s , ∀ t \\ {SoC}_{min}^{es} \leq {SoC}_{n , s , t}^{es} \leq {SoC}_{max}^{es} \\ {SoC}_{n , s , {t}_{0}}^{es} = {SoC}_{n , s , {t}_{N}}^{es}\end{matrix} ;$$

where

$${p}_{n , s , t}^{s}$$

is an external equivalent actual output of the electrochemical energy storage equipment in the n-th stage, s-th scenario, and t-th time period;

$${p}_{n , s , t}^{es , d}$$

is a discharging power of the electrochemical energy storage equipment in the n-th stage, s-th scenario, and t-th time period;

$${p}_{n , s , t}^{es , c}$$

is a charging power of the electrochemical energy storage equipment in the n-th stage, s-th scenario, and t-th time period;

$${P}_{n}^{es}$$

is an installed capacity of the electrochemical energy storage equipment in the n-th stage;

$${SoC}_{n , s , t}^{es}$$

is a state of charge of the electrochemical energy storage equipment in the n-th stage, s-th scenario, and t-th time period;

$$S o {C}_{n , s , t - 1}^{e s}$$

is a state of charge of the electrochemical energy storage equipment in the n-th stage, s-th scenario, and (t−1)-th time period;

$${η}_{n}^{es , c}$$

is charging efficiency of the electrochemical energy storage equipment in the n-th stage;

$${η}_{n}^{es , d}$$

is discharging efficiency of the electrochemical energy storage equipment in the n-th stage;

$${E}_{n}^{es}$$

is rated energy of the electrochemical energy storage equipment in the n-th stage; Δt is a time interval;

$${SoC}_{min}^{es}$$

is a minimum state of charge;

$$S o {C}_{max}^{e s}$$

is a maximum state of charge;

$$So {C}_{n , s , {t}_{0}}^{e s}$$

is an initial state of charge in the n-th stage and s-th scenario; and

$$So {C}_{n , s , {t}_{N}}^{e s}$$

is a state of charge at a final time period in the n-th stage and s-th scenario;
the spinning reserve capacity constraints are:

$$\{ \begin{matrix}min ( {α}_{max}^{g} {b}_{n , s , t}^{g} - {p}_{n , s , t}^{g} , {β}_{up}^{g} {b}_{n , s , t}^{g} ) + {P}_{n}^{es} - {p}_{n , s , t}^{es} \geq \\ {\partial }_{up}^{w} {p}_{n , s , t}^{w} + {\partial }_{up}^{p} {p}_{n , s , t}^{p} + {\partial }_{up}^{load} {p}_{n , s , t}^{load} , ∀ n , ∀ s , ∀ t \\ min ( {p}_{n , s , t}^{g} - {α}_{min}^{g} {b}_{n , s , t}^{g} , {β}_{down}^{g} {b}_{n , s , t}^{g} ) + {P}_{n}^{es} + {p}_{n , s , t}^{es} \geq \\ {\partial }_{do}^{w} {p}_{n , s , t}^{w} + {\partial }_{do}^{p} {p}_{n , s , t}^{p} + {\partial }_{do}^{load} {p}_{n , s , t}^{load} , ∀ n , ∀ s , ∀ t\end{matrix}$$

where

$${p}_{n , s , t}^{e s}$$

is an output power of the electrochemical energy storage equipment in the n-th stage, s-th scenario, and t-th time period;

$${\partial }_{u p}^{w}$$

is a positive reserve coefficient for wind power;

$${\partial }_{u p}^{p}$$

is a positive reserve coefficient for photovoltaic power;

$${\partial }_{u p}^{l o a d}$$

is a positive reserve coefficient for electrical load;

$${p}_{n , s , t}^{l o a d}$$

is a power of electrical load in the n-th stage, s-th scenario, and t-th time period;

$${\partial }_{d o}^{w}$$

is a negative reserve coefficient for wind power;

$${\partial }_{d o}^{p}$$

is a negative reserve coefficient for photovoltaic power; and

$${\partial }_{do}^{load}$$

is a negative reserve coefficient for electrical load;
the clean low-carbon driving constraints include carbon emission limit constraints, new energy generation proportion constraints, and minimum new energy consumption rate constraints;

$$\{ \begin{matrix}{\sum }_{∀ s , ∀ t} {τ}_{s} {δ}_{n}^{g} {p}_{n , s , t}^{g} Δ t \leq {X}_{n}^{co} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} {p}_{n , s , t}^{load}} \geq {X}_{n}^{new} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {p}_{n}^{w} + {c}_{n , s , t}^{p} {p}_{n}^{p} )} \geq {G}_{n}^{pre}\end{matrix}$$

where τₛ is a weight coefficient of the s-th scenario;

$${δ}_{n}^{g}$$

is a carbon emission factor of thermal power in the n-th stage;

$${X}_{n}^{co}$$

is a carbon emission quota in the n-th stage;

$${X}_{n}^{new}$$

is a new energy generation proportion requirement in the n-th stage; and

$${G}_{n}^{pre}$$

is an expected new energy consumption rate in the n-th stage.

Optionally, the determining, based on the initial installed capacity, the installed capacity label corresponding to the upper limit of the one-time investment coefficient and the lower limit of the new energy consumption rate for each stage of the training power system by using the wave search algorithm specifically includes:
normalizing a maximum total cost and a maximum new energy consumption rate corresponding to the installed capacity optimal solution set to obtain a total cost baseline value and a new energy consumption rate baseline value;
solving a reduction process objective function according to the total cost baseline value and the new energy consumption rate baseline value to obtain a reduction process baseline objective value, where the reduction process objective function is Loss=δ^{ƒ}ƒ^{a}+δ^{g}g^{a}; Loss is the reduction process baseline objective value; ƒ^{a} is the total cost baseline value; g^{a} is the new energy consumption rate baseline value; δ^{ƒ} is a weight of an economic indicator; and δ^{g} is a weight of a consumption rate indicator; and
determining the installed capacity label corresponding to the upper limit of the one-time investment coefficient and the lower limit of the new energy consumption rate for each stage of the training power system by using the wave search algorithm according to the total cost baseline value, the new energy consumption rate baseline value, and the reduction process baseline objective value.

According to a second aspect, the present disclosure provides a computer device, including a memory, a processor, and a computer program stored in the memory and executable on the processor, where the processor executes the computer program to implement the method for generating an installed capacity of a power system described above.

According to a third aspect, an embodiment of the present disclosure provides a computer readable storage medium storing a computer program, where the computer program, when executed by a processor, implements the method for generating an installed capacity of a power system described above.

According to a fourth aspect, the present disclosure provides a computer program product, including a computer program, where the computer program, when executed by a processor, implements the method for generating an installed capacity of a power system described above.

According to specific embodiments provided in the present disclosure, the present disclosure achieves the following technical effects:

The present disclosure provides a method for generating an installed capacity of a power system, a device, a medium, and a product. The method includes: acquiring an expected upper limit of a one-time investment coefficient and an expected lower limit of a new energy consumption rate for a target power system; and determining an installed capacity of the target power system by using a power system installed capacity generation model. The installed capacity is defined by an installed capacity upper bound and an installed capacity lower bound, and the power system installed capacity generation model is obtained by training a CNN-BiLSTM-BiGRU neural network model using a training dataset. The training dataset is established using a multi-objective coronavirus disease optimization algorithm and a wave search algorithm. The CNN-BiLSTM-BiGRU neural network model includes a CNN, a BiLSTM neural network, and a BiGRU connected sequentially. The present disclosure improves the accuracy of generating the installed capacity of the power system.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic flowchart of a method for generating an installed capacity of a power system according to an embodiment of the present disclosure;

FIG. 2 is an architecture diagram of a method for generating an installed capacity of a power system according to the present disclosure;

FIG. 3 is an overall flowchart of a method for generating an installed capacity of a power system according to the present disclosure; and

FIG. 4 is a schematic structural diagram of a computer device according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

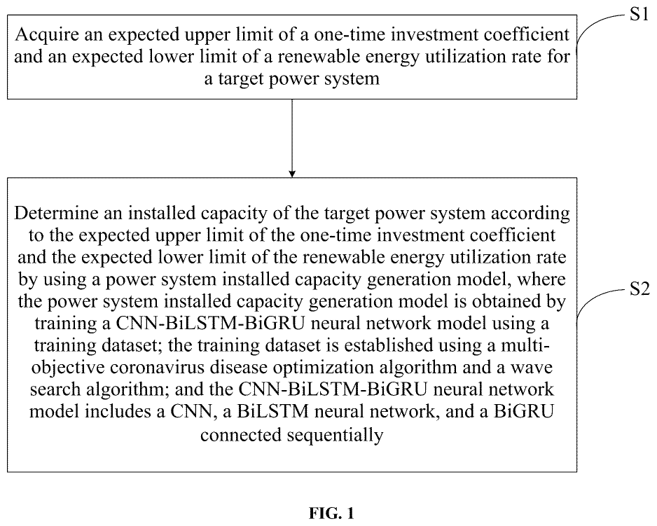

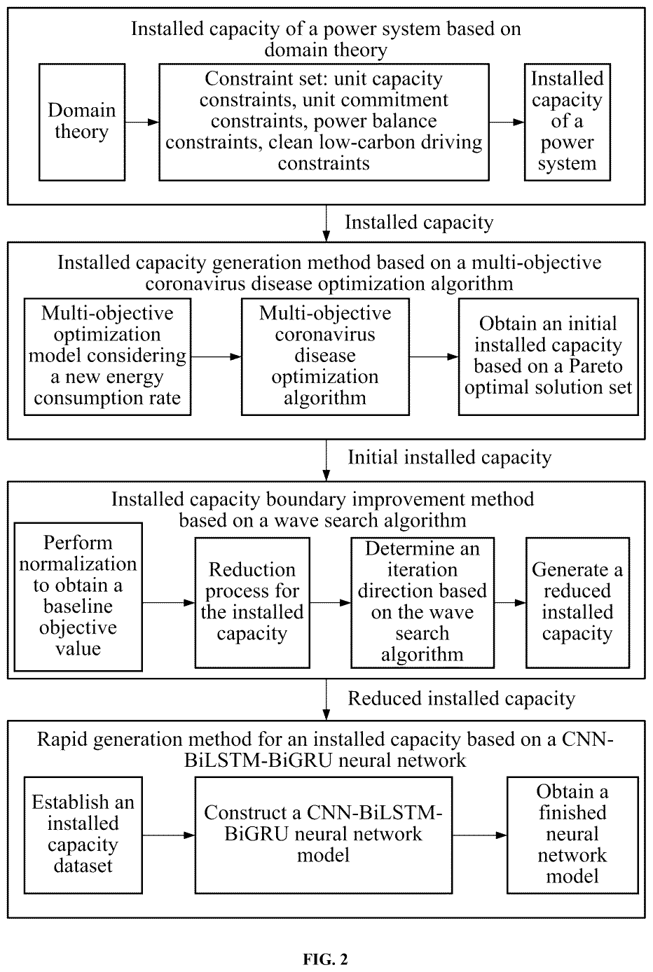

In an exemplary embodiment, as shown in FIG. 1 and FIG. 2, a method for generating an installed capacity of a power system is provided, including the following steps:
S1: Acquire an expected upper limit of a one-time investment coefficient and an expected lower limit of a new energy consumption rate for a target power system.
S2: Determine an installed capacity of the target power system according to the expected upper limit of the one-time investment coefficient and the expected lower limit of the new energy consumption rate by using a power system installed capacity generation model, where the installed capacity is defined by an installed capacity upper bound and an installed capacity lower bound; the power system installed capacity generation model is obtained by training a CNN-BiLSTM-BiGRU neural network model using a training dataset; the training dataset is established using a multi-objective coronavirus disease optimization algorithm and a wave search algorithm; the training dataset includes an upper limit of a one-time investment coefficient, a lower limit of a new energy consumption rate, and a corresponding installed capacity label for each stage of a training power system; and the CNN-BiLSTM-BiGRU neural network model includes a CNN, a BiLSTM neural network, and a BiGRU connected sequentially.

The first layer of the CNN-BiLSTM-BiGRU neural network model uses a CNN and performs max-pooling transformation. Each updated feature vector is considered a new input feature. A convolutional layer and a max-pooling layer aggregate the feature vectors and output a maximum value, effectively reducing the data dimensionality. The second layer uses BiLSTM to capture long-term bidirectional interactions between time steps of sequence data; a Dropout layer is added after the BiLSTM layer to reduce overfitting. The third layer uses a BiGRU, where the BiGRU is a sequence processing model with two Gated Recurrent Units (GRUs), which can process data forwards and backwards.

As an optional implementation manner, the step of training the CNN-BiLSTM-BiGRU neural network model using the training dataset specifically includes:
S21: Construct the training dataset.

The present disclosure also proposes a power system installed capacity based on domain theory.

Firstly, the domain theory utilizes projection observation technology to present implicit mathematical analytical expressions of a system operation model in the form of spatial geometry according to different analysis perspectives, and is an important method supporting the construction of a power system operation space. Using the domain theory, a power system installed capacity is established from the perspective of the installed capacity of wind power, photovoltaic power, thermal power, and electrochemical energy storage in the power system. The power system installed capacity is defined as a set of decision points that satisfy the power balance, reliable operation, and clean low-carbon driving constraints over a long-term scale, considering the power load growth demand and the power source structure characteristics of the power system, and considering the improvement of system economy and new energy utilization capability, where the decision points are an annual installed capacity of each type of power generation equipment. The power system installed capacity model is expressed as follows:

$$Ω = \{ x \vert \begin{matrix}f ( x ) \leq 0 \\ g ( x , y , z ) \leq 0 \\ h ( y , z ) = 0 \\ k ( y , z ) \leq 0\end{matrix} \} \qquad ( 1 )$$

where Ω is the power system installed capacity; x is a key decision vector corresponding to system decision points within a long-term scale, including an installed capacity of each type of power generation equipment in each stage; z represents discrete variables of the system, including on/off status of thermal power units, and charging/discharging status of electrochemical energy storage equipment in each time period; y represents a vector composed of other continuous variables of the system, including specific output status of each unit and other auxiliary variables. ƒ(x)≤0 represents unit capacity constraints; g(x, y, z)≤0 represents unit commitment constraints; h(y, z)=0 represents power balance constraints; and k(y, z)≤0 represents clean low-carbon driving constraints.

Secondly, for the above various types of constraints, specific constraint expressions of the power system installed capacity model are as follows.
1. Constraint type 1: Unit capacity constraints mainly include upper and lower unit capacity constraints, unit capacity connection constraints, and an upper limit constraint of a one-time investment cost.

$$\{ \begin{matrix}{B}_{n}^{k} \leq {P}_{n}^{k} \leq {A}_{n}^{k} , ∀ n , ∀ k \\ {P}_{n}^{k} \leq {P}_{n + 1}^{k} , ∀ n \\ {\sum }_{k ∈ \{ w , p , g , es \}} {a}_{n}^{k} ( {P}_{n}^{k} - {P}_{n - 1}^{k} ) \leq {F}_{n}^{pre} , ∀ n\end{matrix} \qquad ( 2 )$$

where

$${P}_{n}^{k}$$

is an installed capacity of power generation equipment in an n-th stage;

$${P}_{n + 1}^{k}$$

is an installed capacity of the power generation equipment in an (n+1)-th stage;

$${B}_{n}^{k}$$

is a lower limit of the installed capacity in the n-th stage;

$${A}_{n}^{k}$$

is an upper limit of the installed capacity in the n-th stage;

$${a}_{n}^{k}$$

is an investment cost per unit of capacity of the power generation equipment in the n-th stage;

$${P}_{n - 1}^{k}$$

is an installed capacity of the power generation equipment in an (n−1)-th stage; and

$${F}_{n}^{pre}$$

is an expected upper limit of the one-time investment coefficient in the n-th stage.
2. Constraint type 2: Unit commitment constraints mainly include wind and photovoltaic-thermal-storage equipment operation constraints, and spinning reserve capacity constraints.

Wind and photovoltaic power operation constraints are as follows:

$$\{ \begin{matrix}0 \leq {p}_{n , s , t}^{w} \leq {c}_{n , s , t}^{w} {P}_{n}^{w} , ∀ n , ∀ s , ∀ t \\ 0 \leq {p}_{n , s , t}^{p} \leq {c}_{n , s , t}^{p} {P}_{n}^{p} , ∀ n , ∀ s , ∀ t\end{matrix} \qquad ( 3 )$$

where

$${p}_{n , s , t}^{w}$$

is an actual output of wind power in the n-th stage, an s-th scenario, and a t-th time period;

$${p}_{n , s , t}^{p}$$

is an actual output of photovoltaic power in the n-th stage, s-th scenario, and t-th time period;

$${P}_{n}^{w}$$

is an installed capacity of wind power in the n-th stage;

$${P}_{n}^{p}$$

is an installed capacity of photovoltaic power in the n-th stage;

$${c}_{n , s , t}^{p}$$

is a predicted capacity factor of wind power in the n-th stage, s-th scenario, and t-th time period; and

$${c}_{n , s , t}^{w}$$

is a predicted capacity factor of photovoltaic power in the n-th stage, s-th scenario, and t-th time period.

Thermal power operation constraints are as follows:

$$\{ \begin{matrix}{p}_{n , s , t}^{g} - {p}_{n , s , t - 1}^{g} \leq {β}_{u p}^{g} {b}_{n , s , t}^{g} , ∀ n , ∀ s , ∀ t \\ {p}_{n , s , t - 1}^{g} - {p}_{n , s , t}^{g} \leq {β}_{d o w n}^{g} {b}_{n , s , t}^{g} , ∀ n , ∀ s , ∀ t \\ {α}_{min}^{g} {b}_{n , s , t}^{g} \leq {p}_{n , s , t}^{g} \leq {α}_{max}^{g} {b}_{n , s , t}^{g} \leq {P}_{n}^{g} , ∀ n , ∀ s , ∀ t \\ {b}_{n , s , t}^{g} = {\sum }_{j = 1}^{{J}^{g}} {u}_{n , s , t , j}^{g} {P}_{n , j}^{g}\end{matrix} \qquad ( 4 )$$

where

$${p}_{n , s , t}^{g}$$

is an actual output of thermal power in the n-th stage, s-th scenario, and t-th time period;

$${p}_{n , s , t - 1}^{g}$$

is an actual output of thermal power in the n-th stage, s-th scenario, and a (t−1)-th time period;

$${β}_{u p}^{g}$$

is a ramping-up power coefficient of thermal power;

$${b}_{n , s , t}^{g}$$

is a grid-connected capacity of thermal power in the n-th stage, s-th scenario, and t-th time period;

$${β}_{d o w n}^{g}$$

is a ramping-down power coefficient of thermal power;

$${α}_{min}^{g}$$

is a minimum technical output coefficient of thermal power;

$${α}_{max}^{g}$$

is a maximum technical output coefficient of thermal power;

$${p}_{n}^{g}$$

is a total installed capacity of thermal power;

$${p}_{n , j}^{g}$$

is an installed capacity of a j-th thermal power unit in the n-th stage;

$${u}_{n , s , t , j}^{g}$$

is an on/off status of the j-th thermal power unit in the n-th stage, s-th scenario, and t-th time period.

Electrochemical energy storage equipment operation constraints are as follows:

$$\{ \begin{matrix}{p}_{n , s , t}^{s} = {p}_{n , s , t}^{es , d} - {p}_{n , s , t}^{es , c} \\ 0 \leq {p}_{n , s , t}^{es , c} , {p}_{n , s , t}^{es , d} \leq {p}_{n}^{es} \\ {p}_{n , s , t}^{es , c} \times {p}_{n , s , t}^{es , d} = 0 \\ {SoC}_{n , s , t}^{es} = {SoC}_{n , s , t - 1}^{es} + \frac{( {η}_{n}^{es , c} {p}_{n , s , t}^{es , c} - {p}_{n , s , t}^{es , d} / {η}_{n}^{es , d} ) Δ t}{{E}_{n}^{es}} , ∀ n , ∀ s , ∀ t \\ {SoC}_{min}^{es} = {SoC}_{n , s , t}^{es} \leq {SoC}_{max}^{es} \\ {SoC}_{n , s , {t}_{0}}^{es} = {SoC}_{n , s , {t}_{N}}^{es}\end{matrix} \qquad ( 5 )$$

Further, linearization is performed using the Big-M method, introducing binary auxiliary variables.

$$\{ \begin{matrix}{p}_{n , s , t}^{es , c} \leq M ( 1 - {u}_{n , s , t}^{es} ) \\ {p}_{n , s , t}^{es , d} \leq {Mu}_{n , s , t}^{es}\end{matrix} \qquad ( 6 )$$

where

$${p}_{n , s , t}^{s}$$

is an external equivalent actual output of the electrochemical energy storage equipment in the n-th stage, s-th scenario, and t-th time period;

$${p}_{n , s , t}^{es , d}$$

is a discharging power of the electrochemical energy storage equipment in the n-th stage, s-th scenario, and t-th time period;

$${p}_{n , s , t}^{es , c}$$

is a charging power of the electrochemical energy storage equipment in the n-th stage, s-th scenario, and t-th time period;

$${p}_{n}^{es}$$

is an installed capacity of the electrochemical energy storage equipment in the n-th stage;

$${SoC}_{n , s , t}^{es}$$

is a state of charge of the electrochemical energy storage equipment in the n-th stage, s-th scenario, and t-th time period;

$${SoC}_{n , s , t - 1}^{es}$$

is a state of charge of the electrochemical energy storage equipment in the n-th stage, s-th scenario, and (t−1)-th time period;

$${η}_{n}^{es , c}$$

is charging efficiency of the electrochemical energy storage equipment in the n-th stage;

$${η}_{n}^{es , d}$$

is discharging efficiency of the electrochemical energy storage equipment in the n-th stage;

$${E}_{n}^{es}$$

is rated energy of the electrochemical energy storage equipment in the n-th stage; Δt is a time interval;

$${SoC}_{min}^{es}$$

is a minimum state of charge;

$${SoC}_{max}^{es}$$

is a maximum state of charge;

$${SoC}_{n , s , {t}_{0}}^{es}$$

is an initial state of charge in the n-th stage and s-th scenario;

$${SoC}_{n , s , {t}_{N}}^{es}$$

is a state of charge at a final time period in the n-th stage and s-th scenario;

$${u}_{n , s , t}^{es}$$

is a charging/discharging status of the electrochemical energy storage equipment in the n-th stage, s-th scenario, and t-th time period; and M is a constant coefficient.

Spinning reserve capacity constraints are as follows:

$$\{ \begin{matrix}min ( {α}_{max}^{g} {b}_{n , s , t}^{g} - {p}_{n , s , t}^{g} , {β}_{up}^{g} {b}_{n , s , t}^{g} ) + {P}_{n}^{es} - {p}_{n , s , t}^{es} \geq \\ {\partial }_{up}^{w} {p}_{n , s , t}^{w} + {\partial }_{up}^{p} {p}_{n , s , t}^{p} + {\partial }_{up}^{load} {\partial }_{n , s , t}^{load} , ∀ n , ∀ s , ∀ t \\ min ( {p}_{n , s , t}^{g} - {α}_{min}^{g} {b}_{n , s , t}^{g} , {β}_{down}^{g} , {b}_{n , s , t}^{g} ) + {P}_{n}^{es} - {p}_{n , s , t}^{es} \geq \\ {\partial }_{do}^{w} {p}_{n , s , t}^{w} + {\partial }_{do}^{p} {p}_{n , s , t}^{p} + {\partial }_{do}^{load} {p}_{n , s , t}^{load} , ∀ n , ∀ s , ∀ t\end{matrix} \qquad ( 7 )$$

where

$${p}_{n , s , t}^{es}$$

is an output power of the electrochemical energy storage equipment in the n-th stage, s-th scenario, and t-th time period;

$${\partial }_{up}^{w}$$

is a positive reserve coefficient for wind power;

$${\partial }_{up}^{p}$$

is a positive reserve coefficient for photovoltaic power;

$${\partial }_{up}^{load}$$

is a positive reserve coefficient for electrical load;

$${p}_{n , s , t}^{load}$$

is a power of electrical load in the n-th stage, s-th scenario, and t-th time period;

$${\partial }_{do}^{w}$$

is a negative reserve coefficient for wind power;

$${\partial }_{do}^{p}$$

is a negative reserve coefficient for photovoltaic power; and

$${\partial }_{do}^{load}$$

is a negative reserve coefficient for electrical load.
3. Constraint type 3: Power balance constraints

$${p}_{n , s , t}^{w} + {p}_{n , s , t}^{p} + {p}_{n , s , t}^{g} + {p}_{n , s , t}^{es} = {p}_{n , s , t}^{load} , ∀ n , ∀ s , ∀ t \qquad ( 8 )$$

where

$${p}_{n , s , t}^{load}$$

is an actual electrical load.
4. Constraint type 4: Clean low-carbon driving constraints mainly include carbon emission limit constraints, new energy generation proportion constraints, and minimum new energy consumption rate constraints.

$$\{ \begin{matrix}{\sum }_{∀ s , ∀ t} {τ}_{s} {δ}_{n}^{g} {p}_{n , s , t}^{g} Δ t \leq {X}_{n}^{co} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} {p}_{n , s , t}^{l o a d}} \geq {X}_{n}^{n e w} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )} \geq {G}_{n}^{p r e}\end{matrix} \qquad ( 9 )$$

where τₛ is a weight coefficient of the s-th sscenario;

$${δ}_{n}^{g}$$

is a carbon emission factor of thermal power in the n-th stage;

$${X}_{n}^{c o}$$

is a carbon emission quota in the n-th stage;

$${X}_{n}^{n e w}$$

is a new energy generation proportion requirement in the n-th stage; and

$${G}_{n}^{p r e}$$

is an expected new energy consumption rate in the n-th stage.

In practical applications, the specific process for establishing an installed capacity dataset (training dataset) includes: generating the upper limit of the one-time investment cost and the lower limit of the new energy consumption rate for each stage through a random function; further using an installed capacity generation method based on the multi-objective coronavirus disease optimization algorithm and an installed capacity boundary improvement method based on the wave search algorithm to obtain corresponding upper and lower bound data of the installed capacity. The massive generated input data and output data form the installed capacity dataset. A set of data in the installed capacity dataset includes the upper limit of the one-time investment cost, the lower limit of the new energy consumption rate, the upper bound of the installed capacity, and the lower bound of the installed capacity of each stage.

As an optional implementation manner, the step of constructing the training dataset specifically includes:
S211: Generate the upper limit of the one-time investment coefficient and the lower limit of the new energy consumption rate for each stage of the training power system by using a random function.
S212: Generate an initial installed capacity of the training power system by using the multi-objective coronavirus disease optimization algorithm, specifically including the following steps:
Step 1: Establish a multi-objective optimization model, where the multi-objective optimization model takes minimizing a total coefficient and maximizing the new energy consumption rate as objective functions, and takes unit capacity constraints, unit commitment constraints, and clean low-carbon driving constraints as constraint conditions.

The new energy consumption rate is an important assessment indicator for the current power system, and a reasonable power source structure arrangement on the generation side is a key factor affecting the new energy utilization target. To enhance the potential of the installed capacity at the level of new energy utilization, a multi-objective optimization model considering the new energy consumption rate is established, and a Pareto solution set of the multi-objective problem is used to generate the installed capacity.

The multi-objective optimization model considering the new energy consumption rate is as follows:

$$\{ \begin{matrix}\begin{matrix}min {F}^{a} = \frac{1}{{T}_{a}} {\sum }_{∀ k , ∀ n} [ {a}_{n}^{k} ( {P}_{n}^{k} - {P}_{n - 1}^{k} ) + {m}_{n}^{k} {P}_{n}^{k} ] +\end{matrix} \\ {\sum }_{∀ n , ∀ s , ∀ t} {τ}_{s} {e}_{n}^{e s} ( {p}_{n , s , t}^{es , c} + {p}_{n , s , t}^{es , d} ) Δ t + {\sum }_{∀ n , ∀ s , ∀ t} {τ}_{s} {e}_{n}^{g} {p}_{n , s , t}^{g} Δ t + \\ {\sum }_{∀ n , ∀ s , ∀ t} {τ}_{s} {e}_{n}^{c u r} {p}_{n , s , t}^{c u r} Δ t \\ min {G}^{a} = - \frac{1}{{N}_{r}} {\sum }_{∀ n} \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )} \\ s . t . formulas ( 2 ) - ( 7 ) , formula ( 9 ) \\ s . t . {p}_{n , s , t}^{w} + {p}_{n , s , t}^{p} + {p}_{n , s , t}^{g} + {p}_{n , s , t}^{e s} = {p}_{n , s , t}^{l o a d} - {p}_{n , s , t}^{c u r} , ∀ n , ∀ s , ∀ t\end{matrix} \qquad ( 10 )$$

where F^{a} is a total cost; Tₐ is the number of days in a current stage;

$${m}_{n}^{k}$$

is a maintenance cost per unit of capacity of the power generation equipment in the n-th stage;

$${e}_{n}^{e s}$$

is an operating cost per unit of power of the electrochemical energy storage equipment in the n-th stage;

$${e}_{n}^{g}$$

is an operating cost per unit of electricity of thermal power in the n-th stage;

$${e}_{n}^{c u r}$$

is a penalty cost per unit of electricity for load shedding;

$${p}_{n , s , t}^{cur}$$

is an actual load shedding in the n-th stage, s-th scenario, and t-th time period; G^{a} is a new energy consumption rate; and Nᵣ is the number of stages for power generation capacity decision-making.
Step 2: Solve the multi-objective optimization model by using the multi-objective coronavirus disease optimization algorithm to determine an installed capacity optimal solution set.

Secondly, for the above multi-objective optimization problem, a multi-objective coronavirus disease optimization algorithm is used for rapid solution. This algorithm is based on the coronavirus disease optimization algorithm, uses an archive to store non-dominated Pareto optimal solutions during the optimization process, selects effective archive solutions by simulating a coronavirus replication process and using a roulette wheel selection strategy, and has excellent effects in solving global optimization problems with two objective functions.

The coronavirus disease optimization algorithm is a heuristic optimization algorithm inspired by the replication mechanism of coronaviruses hijacking human cells, which is mainly divided into four stages: virus entry and uncoating, virus replication, virus mutation, and new virus release. A search mechanism of the multi-objective coronavirus disease optimization algorithm remains consistent with the coronavirus disease optimization algorithm. Specifically, the multi-objective coronavirus disease optimization algorithm uses a dominance operator to compare solutions considering multiple objective functions. All Pareto optimal solutions obtained during the optimization process are stored in an archive, and an archive controller is used to decide the retention or deletion of solutions in the archive.

The principle of the archive controller is as follows:
1. If the archive is empty, the current solution should be accepted.
2. If another solution in the archive dominates, the current solution should be deleted from the archive.
3. If another solution does not dominate, the current solution should be stored in the archive.

To improve the coverage of the Pareto optimal solutions, it is necessary to select solutions from the least crowded area in the archive to promote improvement in other areas, and solutions with many neighboring solutions should be deleted from the archive. The multi-objective coronavirus disease optimization algorithm (MOVOIDOA) uses a roulette wheel selection strategy to select a solution from an area with the fewest solutions in the archive; when the number of solutions in the archive reaches an upper limit, a solution with many neighboring solutions should be deleted. Probabilities for the two options are as follows:

$$\{ \begin{matrix}{P}_{i}^{O} = \frac{{c}_{MO}}{{N}_{i}^{MO}} \\ {P}_{i}^{D} = \frac{{N}_{i}^{MO}}{{c}_{MO}}\end{matrix} \qquad ( 11 )$$

where

$${P}_{i}^{O}$$

is a probability of selecting a new solution;

$${P}_{i}^{D}$$

is a probability of deleting a solution; c_{MO} is a constant; and

$${N}_{i}^{M O}$$

represents the number of neighboring solutions of an i-th solution.

Finally, the multi-objective coronavirus disease optimization algorithm solves the multi-objective optimization model considering the new energy consumption rate to obtain a Pareto optimal solution set of the multi-objective optimization problem considering the new energy consumption rate. Among all solutions, a maximum power source capacity is selected as the upper bound, and a minimum power source capacity is selected as the lower bound, to obtain the initial installed capacity of each type of power source that expands with increasing stages.
Step 3: Determine the initial installed capacity of the training power system according to the installed capacity optimal solution set, where an upper bound of the initial installed capacity is a maximum power source capacity value in the installed capacity optimal solution set, and a lower bound of the initial installed capacity is a minimum power source capacity value in the installed capacity optimal solution set.
S213: Determine, based on the initial installed capacity, the installed capacity label corresponding to the upper limit of the one-time investment coefficient and the lower limit of the new energy consumption rate for each stage of the training power system by using the wave search algorithm, to obtain the training dataset.

In practical applications, an installed capacity boundary improvement method based on the wave search algorithm is proposed. Using a virtual boundary and iterative optimization method, it integrates economy and new energy consumption rate, gradually reduces the installed capacity, and effectively improves the effectiveness of the installed capacity.

As an optional implementation manner, the step of determining, based on the initial installed capacity, the installed capacity label corresponding to the upper limit of the one-time investment coefficient and the lower limit of the new energy consumption rate for each stage of the training power system by using the wave search algorithm specifically includes:
(1) Normalize a maximum total cost and a maximum new energy consumption rate corresponding to the installed capacity optimal solution set to obtain a total cost baseline value and a new energy consumption rate baseline value.

First, the maximum total cost and the maximum new energy consumption rate are extracted from the Pareto optimal solution set (installed capacity optimal solution set) in step 2. The economic indicator (corresponding to the total cost) and the consumption rate indicator (corresponding to the new energy consumption rate) of the capacity design scheme can be normalized.

Further, using the principle of fairness, a capacity design scheme is extracted from the Pareto optimal solution set, and the total cost and the new energy consumption rate under this scheme are considered as baseline values. After normalization, a baseline economic indicator (total cost baseline value) and a baseline consumption rate indicator (new energy consumption rate baseline value) are obtained.

$$\{ \begin{matrix}Δ {F}^{a} = {F}^{a} / {F}_{min}^{a} \\ Δ {G}^{a} = {G}^{a} / {G}_{min}^{a} \\ \frac{Δ {F}^{a}}{Δ {G}^{a}} \to 1\end{matrix} \qquad ( 12 )$$

$$\{ \begin{matrix}{f}_{bo}^{a} = {F}^{a} / {F}_{max}^{a} \\ {g}_{bo}^{a} = {G}^{a} / {G}_{max}^{a}\end{matrix} \qquad ( 13 )$$

where ΔF^{a} is a total cost increment;

$${F}_{min}^{a}$$

is a minimum total cost value;

$${F}_{max}^{a}$$

is a maximum total cost value; ΔG^{a} is a new energy consumption rate increment;

$${G}_{min}^{a}$$

is a minimum value of the new energy consumption rate increment;

$${G}_{max}^{a}$$

is a maximum value of the new energy consumption rate increment;

$${f}_{bo}^{a}$$

is a normalized total cost baseline value; and

$${g}_{bo}^{a}$$

is a normalized new energy consumption rate baseline value.
(2) Solve a reduction process objective function according to the total cost baseline value and the new energy consumption rate baseline value to obtain a reduction process baseline objective value, where the reduction process objective function is Loss=δ^{ƒ}ƒ^{a}+δ^{g} g^{a}; Loss is the reduction process baseline objective value; ƒ^{a} is the total cost baseline value; g^{a} is the new energy consumption rate baseline value; δ^{ƒ} is a weight of an economic indicator; and δ^{g} is a weight of a consumption rate indicator.

Secondly, using a virtual boundary and iterative optimization method, a reduction process for the installed capacity is proposed.

The objective function of the reduction process for the installed capacity is described below, and a reduction process baseline objective value can be obtained based on the baseline economic indicator and the baseline consumption rate indicator.

$$Loss = {δ}^{f} {f}^{a} + {δ}^{g} {g}^{a} \qquad ( 14 )$$

where ƒ^{a} is the total cost baseline value; g^{a} is the new energy consumption rate baseline value; δ^{ƒ} is the weight of the economic indicator; and δ^{g} is the weight of the consumption rate indicator.
(3) Determine the installed capacity label corresponding to the upper limit of the one-time investment coefficient and the lower limit of the new energy consumption rate for each stage of the training power system by using the wave search algorithm according to the total cost baseline value, the new energy consumption rate baseline value, and the reduction process baseline objective value.
1. The capacity of each type of power generation equipment is initialized using a random function within the initial installed capacity, and a reduction process objective value is calculated under the reduction process objective function and compared with the reduction process baseline objective value.
2. The upper bound and lower bound of the installed capacity of the power generation are described using a virtual boundary.

If the reduction process objective value is inferior to the reduction process baseline objective value, virtual boundary sub-elements are corrected based on distances to the upper and lower bounds of the initial installed capacity. The virtual boundary sub-elements are averaged with neighboring boundary elements of the initial installed capacity to generate new virtual upper and lower bounds.

If the reduction process objective value is superior to the reduction process baseline objective value, the virtual boundary sub-elements start from the current capacity, and the virtual boundary repels towards both sides to generate new virtual upper and lower bounds. A repulsion range coefficient is determined based on the degree of excellence of the current objective value.

$${R}_{ex} = {α}_{ex} ( \frac{{Loss}_{bo} - Loss}{{Loss}_{bo}} ) \qquad ( 15 )$$

where Rₑₓ is the repulsion range coefficient; αₑₓ is a constant coefficient; and Loss_{bo} is the reduction process baseline objective value.
3. The capacity of the power generation equipment is continuously updated using the wave search algorithm; new virtual boundaries are generated until a fluctuation range of the virtual boundary is less than a set threshold, and then the iteration is terminated.

$$\sqrt{\frac{1}{{N}_{r}} {\sum }_{n = 1}^{{N}_{r}} {( {P}_{n , i + 1}^{k} - {P}_{n , i}^{k} )}^{2}} \leq {γ}^{k} , ∀ k \qquad ( 16 )$$

where Nᵣ is the number of stages for power generation capacity decision-making; and γ^{k} is a set threshold coefficient.

Finally, an iteration direction is determined using the wave search algorithm, and convergence is accelerated.

The wave search algorithm (WSA) utilizes the unique algorithmic design concept of radar technology, employs various improved greedy mechanisms, and uses gradient information of a problem to be optimized, achieving the algorithm characteristics such as high accuracy, high efficiency, and strong adaptability. The present disclosure uses the wave search algorithm to determine the iteration direction, and this process is specifically divided into three phases: transmitting electromagnetic waves, reflecting electromagnetic waves, and receiving electromagnetic waves. Furthermore, a fitting gradient descent method based on the central difference method is introduced to improve search efficiency and accuracy. The specific process is as follows: based on initialized electromagnetic wave particle positions, sequentially updating the positions through the three stages of transmitting electromagnetic waves, reflecting electromagnetic waves, and receiving electromagnetic waves; further improving position information through the fitting gradient descent method based on the central difference method to complete this iteration; and continuously iterating and updating the positions until the maximum number of iterations is reached.

The phase of transmitting electromagnetic waves employs the following strategy:

$${X}_{i}^{new} = {X}_{best} + [ ( {X}_{i}^{l} - {X}_{best} ) ( 1 + {m}_{i}^{w} ) ] / {σ}^{w} \qquad ( 17 )$$

$${X}_{i} = \{ \begin{matrix}{X}_{i}^{new} , L ( {X}_{i}^{new} ) \leq {L}_{max} \\ {X}_{i} , otherwise\end{matrix} \qquad ( 18 )$$

where σ^{w} is a waveform control coefficient;

$${m}_{i}^{w}$$

is an i-th element of a column vector following a normal distribution and arranged in order; X_{best} is a current optimal position; Xᵢ is a current position;

$${X}_{i}^{l}$$

is a position matrix rearranged according to the proximity to X_{best};

$${X}_{i}^{new}$$

is a newly generated position; Lₘₐₓ is a maximum objective value within the group.

The function of formula (17) is to simulate the outward diffusion of electromagnetic waves, reduce the possibility of falling into local optima, and improve search efficiency. Formula (18) is an improved greedy mechanism, whose function is to ensure that the group position is not inferior to the current group position when the group position fluctuates outward.

The phase of reflecting electromagnetic waves employs the following strategy:

$${X}_{i}^{new} = - {β}^{w} {r}_{1}^{w} \cdot cos ( π i / {n}_{i}^{w} ) \cdot ( {X}_{best} - {X}_{i}^{f} ) + {X}_{i}^{f} \qquad ( 19 )$$

$${X}_{i} = \{ \begin{matrix}{X}_{i}^{new} , L ( {X}_{i}^{new} ) \leq L ( {X}_{i} ) \\ {X}_{i} , otherwise\end{matrix} \qquad ( 20 )$$

where β^{w} is a reflection intensity coefficient;

$${r}_{1}^{w}$$

is a random value between 0 and 1;

$${n}_{1}^{w}$$

is the number of particles simulating reflected electromagnetic waves.

$${X}_{i}^{f}$$

is a position matrix rearranged in ascending order of objective values.

The phase of receiving electromagnetic waves employs the following strategy: The update determining strategy for electromagnetic wave particles in the phase of receiving electromagnetic waves is consistent with formula (20) in the phase of reflecting electromagnetic waves.

$${X}_{i}^{new} = \{ \begin{matrix}{X}_{i} + {δ}^{w} {r}_{2}^{w} ( {X}_{best} - {X}_{i} ) + {η}^{w} \cdot cos ( π i / {n}_{2}^{w} ) \cdot ( {X}_{best} - {X}_{i} ) , {r}_{5}^{w} \leq 0.95 \\ {X}_{i} + {λ}^{w} {r}_{3}^{w} ( {X}_{best} - {X}_{i} ) + 0.5 {r}_{4}^{w} ( 1 - {λ}^{w} ) ( {X}_{best}^{*} - {X}_{i} ) , otherwise\end{matrix} \qquad ( 21 )$$

where δ^{w} is a reception coefficient; η^{w} is a random number following a normal distribution;

$${n}_{2}^{w}$$

is the number of particles simulating received electromagnetic waves.

$${X}_{best}^{*}$$

is a uniformly optimal position; λ^{w} is a correction factor;

$${r}_{2}^{w} , {r}_{3}^{w} , {r}_{4}^{w} , and {r}_{5}^{w}$$

are random values between 0 and 1.

Furthermore, a deterministic optimization technique, namely the fitting gradient descent method based on the central difference method, is introduced. This method uses the central difference method to fit the analytical information of the problem to be optimized, for searching the optimal solution, thereby improving search efficiency and accuracy. A mathematical expression thereof is as follows:

$$\{ \begin{matrix}{g}_{i}^{w} = [ L ( {X}_{i}^{+ ε} ) - L ( {X}_{i}^{- ε} ) ] / 2 ε \\ {X}_{i} = {X}_{i} - {α}^{w} {g}_{i}^{w}\end{matrix} \qquad ( 22 )$$

where

$${X}_{i}^{+ ε} = {X}_{i} + ε , {X}_{i}^{- ε} = {X}_{i} - ε , ε = {10}^{- 6} , and {g}_{i}^{w}$$

is an i-th element of the gradient; and α^{w} is a step size coefficient.
S22: Input the upper limit of the one-time investment coefficient and the lower limit of the new energy consumption rate for each stage of the training power system into a current CNN-BiLSTM-BiGRU neural network model to obtain a predicted value of the installed capacity upper bound and a predicted value of the installed capacity lower bound.
S23: Determine a loss function value according to the predicted value of the installed capacity upper bound, the predicted value of the installed capacity lower bound, and the corresponding installed capacity label.
S24: Determine whether a training termination condition is satisfied, where the training termination condition is that a maximum number of iterations is reached or that the loss function value is less than a preset value.
S25: If yes, terminate the training, and use the current CNN-BiLSTM-BiGRU neural network model as the power system installed capacity generation model.
S26: If not, adjust model parameters of the current CNN-BiLSTM-BiGRU neural network model according to the loss function value, and return to the step of “inputting the upper limit of the one-time investment coefficient and the lower limit of the new energy consumption rate for each stage of the training power system into the current CNN-BiLSTM-BiGRU neural network model to obtain the predicted value of the installed capacity upper bound and the predicted value of the installed capacity lower bound”.

In practical applications, the installed capacity dataset is input into the CNN-BiLSTM-BiGRU neural network model for continuous training. After the training is completed, a finished neural network model is obtained. By inputting the expected upper limit of the one-time investment coefficient and the expected lower limit of the new energy consumption rate into the CNN-BiLSTM-BiGRU neural network model, the corresponding installed capacity upper bound and installed capacity lower bound can be quickly obtained.

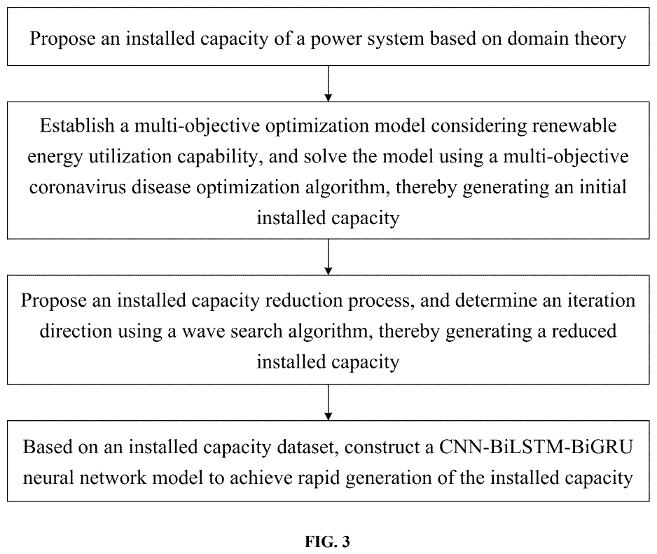

In the method for generating an installed capacity of a power system proposed in the present disclosure, as shown in FIG. 3, an installed capacity of a power system is first proposed based on domain theory; secondly, a multi-objective optimization model considering new energy utilization capability is established, and is solved using a multi-objective coronavirus disease optimization algorithm, thereby generating an initial installed capacity; thirdly, an installed capacity reduction process is proposed using a virtual boundary and iterative optimization method, and an iteration direction is determined using a wave search algorithm, thereby generating a reduced installed capacity. Finally, based on an installed capacity dataset, a CNN-BiLSTM-BiGRU neural network model is constructed to achieve rapid generation of the installed capacity.

The present disclosure provides a method for generating an installed capacity of a power system, achieving the following advantages:
(1) The power system installed capacity based on domain theory proposed in the present disclosure can comprehensively describe the multi-dimensional attributes and constraints of the power system capacity, clearly display the boundaries and potential bottlenecks of the power system capacity, and provide an intuitive and powerful decision support tool for decision-makers.
(2) The present disclosure utilizes the multi-objective coronavirus disease optimization algorithm to achieve rapid solution of the multi-objective optimization problem considering new energy utilization capability. By leveraging the excellent global search and local optimization capabilities of the algorithm, it can achieve rapid optimization under complex multi-objective problems, thereby improving the efficiency and effectiveness of optimization.
(3) The present disclosure proposes an installed capacity reduction process using virtual boundaries and iterative optimization, and utilizes the wave search algorithm to determine the iteration direction. By using the dynamic characteristics of waves for search and optimization, it can quickly cover the search space, accelerate the convergence process, and improve computational efficiency.
(4) The present disclosure adopts a CNN-BiLSTM-BiGRU neural network model, combining the advantages of CNN, BiLSTM, and BiGRU. It possesses powerful time-series feature extraction and processing capabilities, and can comprehensively capture complex relationships in the data. The finished neural network model can quickly generate installed capacity boundaries using input data. It significantly improves the accuracy of generating the installed capacity and is expected to provide strong decision support for the efficient management and optimization of the power source structure of the power system.

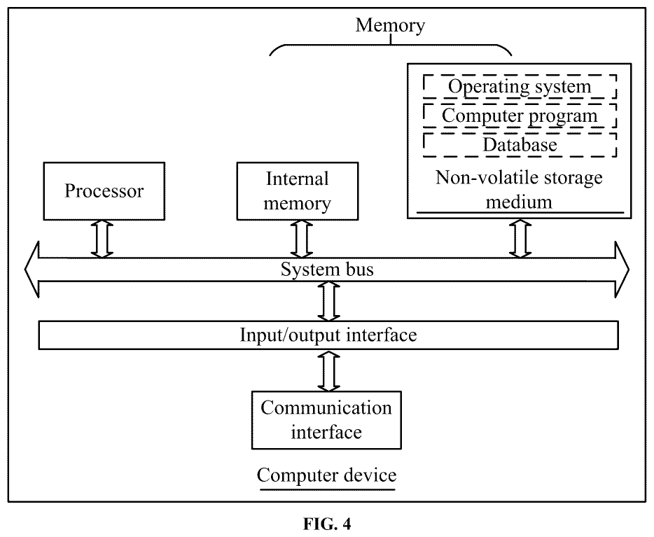

In an embodiment, a computer device is provided. The computer device may be a server or a terminal, and an internal structure thereof may be shown in FIG. 4. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer apparatus includes a nonvolatile storage medium, and an internal memory. The non-volatile storage medium stores an operating system, a computer program, and a database. The internal memory provides an environment for operation of the operating system and the computer program in the nonvolatile storage medium. The input/output interface of the computer apparatus is configured to exchange information between the processor and an external apparatus. The communication interface of the computer apparatus is configured to communicate with an external terminal through a network. The computer program, when executed by a processor, implements a method for generating an installed capacity of a power system.

Those skilled in the art may understand that the structure shown in FIG. 4 is only a block diagram of a part of the structure related to the solutions of the present disclosure and does not constitute a limitation on a computer device to which the solutions of the present disclosure are applied. Specifically, the computer device may include more or fewer components than those shown in the figure, or combine some components, or have different component arrangements.

In an exemplary embodiment, a computer device is provided, including a memory and a processor, where the memory stores a computer program, and the computer program, when executed by the processor, implements the foregoing method for generating an installed capacity of a power system.

In an exemplary embodiment, a computer-readable storage medium is provided. The computer-readable storage medium stores a computer program, and the computer program, when executed by a processor, implements the foregoing method for generating an installed capacity of a power system.

In an exemplary embodiment, a computer program product is provided, including a computer program. The computer program, when executed by a processor, implements the foregoing method for generating an installed capacity of a power system.

It is to be noted that the information of a user (including but not limited to device information of the user, personal information of the user and the like) and data (including but not limited to data for analysis, data for storage, data for exhibition and the like) in the present disclosure are information and data authorized by the user or fully authorized by each party, and the information and data are acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A method for generating an installed capacity of a power system, comprising:
acquiring an expected upper limit of a one-time investment coefficient and an expected lower limit of a new energy consumption rate for a target power system; and
determining an installed capacity of the target power system according to the expected upper limit of the one-time investment coefficient and the expected lower limit of the new energy consumption rate by using a power system installed capacity generation model, wherein the installed capacity is defined by an installed capacity upper bound and an installed capacity lower bound; the power system installed capacity generation model is obtained by training a Convolutional Neural Network (CNN)-Bidirectional Long Short-Term Memory (BiLSTM)-Bidirectional Gated Recurrent Unit (BiGRU) neural network model using a training dataset; the training dataset is established using a multi-objective coronavirus disease optimization algorithm and a wave search algorithm; the training dataset comprises an upper limit of a one-time investment coefficient, a lower limit of a new energy consumption rate, and a corresponding installed capacity label for each stage of a training power system; and the CNN-BiLSTM-BiGRU neural network model comprises a CNN, a BiLSTM neural network, and a BiGRU connected sequentially.

2. The method for generating an installed capacity of a power system according to claim 1, wherein the training the CNN-BiLSTM-BiGRU neural network model using the training dataset comprises:
constructing the training dataset;
inputting the upper limit of the one-time investment coefficient and the lower limit of the new energy consumption rate for each stage of the training power system into a current CNN-BiLSTM-BiGRU neural network model to obtain a predicted value of the installed capacity upper bound and a predicted value of the installed capacity lower bound;
determining a loss function value according to the predicted value of the installed capacity upper bound, the predicted value of the installed capacity lower bound, and the corresponding installed capacity label;
determining whether a training termination condition is satisfied, wherein the training termination condition is that a maximum number of iterations is reached or that the loss function value is less than a preset value;
if the training termination condition is satisfied, terminating the training, and using the current CNN-BiLSTM-BiGRU neural network model as the power system installed capacity generation model; or
if the training termination condition is not satisfied, adjusting model parameters of the current CNN-BiLSTM-BiGRU neural network model according to the loss function value, and returning to step of “inputting the upper limit of the one-time investment coefficient and the lower limit of the new energy consumption rate for each stage of the training power system into the current CNN-BiLSTM-BiGRU neural network model to obtain the predicted value of the installed capacity upper bound and the predicted value of the installed capacity lower bound”.

3. The method for generating an installed capacity of a power system according to claim 1, wherein constructing the training dataset comprises:
generating the upper limit of the one-time investment coefficient and the lower limit of the new energy consumption rate for each stage of the training power system by using a random function;
generating an initial installed capacity of the training power system by using the multi-objective coronavirus disease optimization algorithm; and
determining, based on the initial installed capacity, the installed capacity label corresponding to the upper limit of the one-time investment coefficient and the lower limit of the new energy consumption rate for each stage of the training power system by using the wave search algorithm, to obtain the training dataset.

4. The method for generating an installed capacity of a power system according to claim 3, wherein the generating the initial installed capacity of the training power system by using the multi-objective coronavirus disease optimization algorithm comprises:
establishing a multi-objective optimization model, wherein the multi-objective optimization model takes minimizing a total coefficient and maximizing the new energy consumption rate as objective functions, and takes unit capacity constraints, unit commitment constraints, and clean low-carbon driving constraints as constraint conditions;
solving the multi-objective optimization model by using the multi-objective coronavirus disease optimization algorithm to determine an installed capacity optimal solution set; and
determining the initial installed capacity of the training power system according to the installed capacity optimal solution set, wherein an upper bound of the initial installed capacity is a maximum power source capacity value in the installed capacity optimal solution set, and a lower bound of the initial installed capacity is a minimum power source capacity value in the installed capacity optimal solution set.

5. The method for generating an installed capacity of a power system according to claim 4, wherein the objective functions are:
$$\{ \begin{matrix}min {F}^{a} = \frac{1}{{T}_{a}} {\sum }_{∀ k , ∀ n} [ {a}_{n}^{k} ( {P}_{n}^{k} - {P}_{n - 1}^{k} ) + {m}_{n}^{k} {P}_{n}^{k} ] + {\sum }_{∀ n , ∀ s , ∀ t} {τ}_{s} {e}_{n}^{es} ( {p}_{n , s , t}^{es , c} + {p}_{n , s , t}^{es , d} ) Δ t + {\sum }_{∀ n , ∀ s , ∀ t} {τ}_{s} {e}_{n}^{g} {p}_{n , s , t}^{g} Δ t + {\sum }_{∀ n , ∀ s , ∀ t} {τ}_{s} {e}_{n}^{cur} {p}_{n , s , t}^{cur} Δ t \\ min {G}^{a} = - \frac{1}{{N}_{r}} {\sum }_{∀ n} \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )}\end{matrix}$$
wherein F^{a} is a total cost; Tₐ is a number of days in a current stage;
$${a}_{n}^{k}$$
is an investment cost per unit of capacity of power generation equipment in an n-th stage;
$${P}_{n}^{k}$$
is an installed capacity of the power generation equipment in the n-th stage;
$${P}_{n - 1}^{k}$$
is an installed capacity of the power generation equipment in an (n−1)-th stage;
$${m}_{n}^{k}$$
is a maintenance cost per unit of capacity of the power generation equipment in the n-th stage; τₛ is a weight coefficient of an s-th scenario;
$${e}_{n}^{es}$$
is an operating cost per unit of power of electrochemical energy storage equipment in the n-th stage;
$${p}_{n , s , t}^{es , c}$$
is a charging power of the electrochemical energy storage equipment in the n-th stage, s-th scenario, and a t-th time period;
$${p}_{n , s , t}^{es , d}$$
is a discharging power of the electrochemical energy storage equipment in the n-th stage, s-th scenario, and t-th time period; Δt is a time interval;
$${e}_{n}^{g}$$
is an operating cost per unit of electricity of thermal power in the n-th stage;
$${p}_{n , s , t}^{g}$$
is an actual output of thermal power in the n-th stage, s-th scenario, and t-th time period;
$${e}_{n}^{cur}$$
is a penalty cost per unit of electricity for load shedding;
$${p}_{n , s , t}^{cur}$$
is an actual load shedding in the n-th stage, s-th scenario, and t-th time period; G^{a} is a new energy consumption rate; Nᵣ is the number of stages for power generation capacity decision-making;
$${p}_{n , s , t}^{w}$$
is an actual output of wind power in the n-th stage, s-th scenario, and t-th time period;
$${p}_{n , s , t}^{p}$$
is an actual output of photovoltaic power in the n-th stage, s-th scenario, and t-th time period;
$${P}_{n}^{w}$$
is an installed capacity of wind power in the n-th stage;
$${P}_{n}^{p}$$
is an installed capacity of photovoltaic power in the n-th stage;
$${c}_{n , s , t}^{w}$$
is a predicted capacity factor of wind power in the n-th stage, s-th scenario, and t-th time period; and
$${c}_{n , s , t}^{p}$$
is a predicted capacity factor of photovoltaic power in the n-th stage, s-th scenario, and t-th time period.

6. The method for generating an installed capacity of a power system according to claim 4, wherein the unit capacity constraints are:
$$\{ \begin{matrix}{B}_{n}^{k} \leq {P}_{n}^{k} \leq {A}_{n}^{k} , ∀ n , ∀ k \\ {P}_{n}^{k} \leq {P}_{n + 1}^{k} , ∀ n \\ {\sum }_{k ∈ \{ w , p , g , es \}} {a}_{n}^{k} ( {P}_{n}^{k} - {P}_{n - 1}^{k} ) \leq {F}_{n}^{pre} , ∀ n\end{matrix}$$
wherein
$${P}_{n}^{k}$$
is an installed capacity of power generation equipment in an n-th stage;
$${P}_{n + 1}^{k}$$
is an installed capacity of the power generation equipment in an (n+1)-th stage;
$${B}_{n}^{k}$$
is a lower limit of the installed capacity in the n-th stage;
$${A}_{n}^{k}$$
is an upper limit of the installed capacity in the n-th stage;
$${a}_{n}^{k}$$
is an investment cost per unit of capacity of the power generation equipment in the n-th stage;
$${P}_{n - 1}^{k}$$
is an installed capacity of the power generation equipment in an (n−1)-th stage; and
$${F}_{n}^{p r e}$$
is an expected upper limit of the one-time investment coefficient in the n-th stage;
the unit commitment constraints comprise wind and photovoltaic power operation constraints, thermal power operation constraints, electrochemical energy storage equipment operation constraints, and spinning reserve capacity constraints;
the wind and photovoltaic power operation constraints are:
$$\{ \begin{matrix}0 \leq {p}_{n , s , t}^{w} \leq {c}_{n , s , t}^{w} {P}_{n}^{w} , ∀ n , ∀ s , ∀ t \\ 0 \leq {p}_{n , s , t}^{p} \leq {c}_{n , s , t}^{p} {P}_{n}^{p} , ∀ n , ∀ s , ∀ t\end{matrix} ;$$
wherein
$${p}_{n , s , t}^{w}$$
is an actual output of wind power in the n-th stage, an s-th scenario, and a t-th time period;
$${p}_{n , s , t}^{p}$$
is an actual output of photovoltaic power in the n-th stage, s-th scenario, and t-th time period;
$${P}_{n}^{w}$$
is an installed capacity of wind power in the n-th stage;
$${P}_{n}^{p}$$
is an installed capacity of photovoltaic power in the n-th stage;
$${c}_{n , s , t}^{w}$$
is a predicted capacity factor of wind power in the n-th stage, s-th scenario, and t-th time period; and
$${c}_{n , s , t}^{p}$$
is a predicted capacity factor of photovoltaic power in the n-th stage, s-th scenario, and t-th time period;
the thermal power operation constraints are:
$$\{ \begin{matrix}{p}_{n , s , t}^{g} - {p}_{n , s , t - 1}^{g} \leq {β}_{u p}^{g} {b}_{n , s , t}^{g} , ∀ n , ∀ s , ∀ t \\ {p}_{n , s , t - 1}^{g} - {p}_{n , s , t}^{g} \leq {β}_{d o w n}^{g} {b}_{n , s , t}^{g} , ∀ n , ∀ s , ∀ t \\ {α}_{min}^{g} {b}_{n , s , t}^{g} \leq {p}_{n , s , t}^{g} \leq {α}_{max}^{g} {b}_{n , s , t}^{g} \leq {P}_{n , s , t}^{g} , ∀ n , ∀ s , ∀ t \\ {b}_{n , s , t}^{g} = {\sum }_{j = 1}^{{J}^{g}} {u}_{n , s , t , j}^{g} {P}_{n , j}^{g}\end{matrix}$$
wherein
$${p}_{n , s , t}^{g}$$
is an actual output of thermal power in the n-th stage, s-th scenario, and t-th time period;
$${p}_{n , s , t - 1}^{g}$$
is an actual output of thermal power in the n-th stage, s-th scenario, and a (t−1)-th time period;
$${β}_{up}^{g}$$
is a ramping-up power coefficient of thermal power;
$${b}_{n , s , t}^{g}$$
is a grid-connected capacity of thermal power in the n-th stage, s-th scenario, and t-th time period;
$${β}_{down}^{g}$$
is a ramping-down power coefficient of thermal power;
$${α}_{min}^{g}$$
is a minimum technical output coefficient of thermal power;
$${α}_{max}^{g}$$
is a maximum technical output coefficient of thermal power;
$${P}_{n}^{g}$$
is a total installed capacity of thermal power;
$${P}_{n , j}^{g}$$
is an installed capacity of a j-th thermal power unit in the n-th stage;
$${u}_{n , s , t , j}^{g}$$
is an on/off status of the j-th thermal power unit in the n-th stage, s-th scenario, and t-th time period;
the electrochemical energy storage equipment operation constraints are:
$$\{ \begin{matrix}{p}_{n , s , t}^{s} = {p}_{n , s , t}^{es , d} - {p}_{n , s , t}^{es , c} \\ 0 \leq {p}_{n , s , t}^{es , c} , {p}_{n , s , t}^{es , d} \leq {P}_{n}^{es} \\ {p}_{n , s , t}^{es , c} \times {p}_{n , s , t}^{es , d} = 0 \\ {SoC}_{n , s , t}^{es} = {SoC}_{n , s , t - 1}^{es} + \frac{( {η}_{n}^{es , c} {p}_{n , s , t}^{es , c} - {p}_{n , s , t}^{es , d} / {η}_{n}^{es , d} ) Δ t}{{E}_{n}^{es}} , ∀ n , ∀ s , ∀ t \\ {SoC}_{min}^{es} \leq {SoC}_{n , s , t}^{es} \leq {SoC}_{max}^{es} \\ {SoC}_{n , s , {t}_{0}}^{es} = {SoC}_{n , s , {t}_{N}}^{es}\end{matrix} ;$$
wherein
$${p}_{n , s , t}^{s}$$
is an external equivalent actual output of the electrochemical energy storage equipment in the n-th stage, s-th scenario, and t-th time period;
$${p}_{n , s , t}^{es , d}$$
is a discharging power of the electrochemical energy storage equipment in the n-th stage, s-th scenario, and t-th time period;
$${p}_{n , s , t}^{es , c}$$
is a charging power of the electrochemical energy storage equipment in the n-th stage, s-th scenario, and t-th time period;
$${P}_{n}^{es}$$
is an installed capacity of the electrochemical energy storage equipment in the n-th stage;
$${SoC}_{n , s , t}^{es}$$
is a state of charge of the electrochemical energy storage equipment in the n-th stage, s-th scenario, and t-th time period;
$${SoC}_{n , s , t - 1}^{es}$$
is a state of charge of the electrochemical energy storage equipment in the n-th stage, s-th scenario, and (t−1)-th time period;
$${η}_{n}^{es , c}$$
is charging efficiency of the electrochemical energy storage equipment in the n-th stage;
$${η}_{n}^{es , d}$$
is discharging efficiency of the electrochemical energy storage equipment in the n-th stage;
$${E}_{n}^{es}$$
is rated energy of the electrochemical energy storage equipment in the n-th stage; Δt is a time interval;
$${SoC}_{min}^{es}$$
is a minimum state of charge;
$${SoC}_{max}^{es}$$
is a maximum state of charge;
$${SoC}_{n , s , {t}_{0}}^{es}$$
is an initial state of charge in the n-th stage and s-th scenario; and
$${SoC}_{n , s , {t}_{N}}^{es}$$
is a state of charge at a final time period in the n-th stage and s-th scenario;
the spinning reserve capacity constraints are:
$$\{ \begin{matrix}min ( {α}_{max}^{g} {b}_{n , s , t}^{g} - {p}_{n , s , t}^{g} , {β}_{up}^{g} {b}_{n , s , t}^{g} ) + {P}_{n}^{es} - {p}_{n , s , t}^{es} \geq \\ {\partial }_{up}^{w} {p}_{n , s , t}^{w} + {\partial }_{up}^{p} {p}_{n , s , t}^{p} + {\partial }_{up}^{load} {p}_{n , s , t}^{load} , ∀ n , ∀ s , ∀ t \\ min ( {p}_{n , s , t}^{g} - {α}_{min}^{g} {b}_{n , s , t}^{g} , {β}_{down}^{g} {b}_{n , s , t}^{g} ) + {P}_{n}^{es} + {p}_{n , s , t}^{es} \geq \\ {\partial }_{do}^{w} {p}_{n , s , t}^{w} + {\partial }_{do}^{p} {p}_{n , s , t}^{p} + {\partial }_{do}^{load} {p}_{n , s , t}^{load} , ∀ n , ∀ s , ∀ t\end{matrix} ;$$
wherein
$${p}_{n , s , t}^{es}$$
is an output power of the electrochemical energy storage equipment in the n-th stage, s-th scenario, and t-th time period;
$${\partial }_{up}^{w}$$
is a positive reserve coefficient for wind power;
$${\partial }_{up}^{p}$$
is a positive reserve coefficient for photovoltaic power;
$${\partial }_{up}^{load}$$
is a positive reserve coefficient for electrical load;
$${p}_{n , s , t}^{load}$$
is a is a power of electrical load in the n-th stage, s-th scenario, and t-th time period;
$${\partial }_{do}^{w}$$
is a negative reserve coefficient for wind power;
$${\partial }_{do}^{p}$$
is a negative reserve coefficient for photovoltaic power; and
$${\partial }_{do}^{load}$$
is a negative reserve coefficient for electrical load;
the clean low-carbon driving constraints comprise carbon emission limit constraints, new energy generation proportion constraints, and minimum new energy consumption rate constraints;
$$\{ \begin{matrix}{\sum }_{∀ s , ∀ t} {τ}_{s} {δ}_{n}^{g} {p}_{n , s , t}^{g} Δ t \leq {X}_{n}^{co} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} {p}_{n , s , t}^{load}} \geq {X}_{n}^{new} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )} \geq {G}_{n}^{pre}\end{matrix}$$
wherein τₛ is a weight coefficient of the s-th scenario;
$${δ}_{n}^{g}$$
is a carbon emission factor of thermal power in the n-th stage;
$${X}_{n}^{co}$$
is a carbon emission quota in the n-th stage;
$${X}_{n}^{new}$$
is a new energy generation proportion requirement in the n-th stage; and
$${G}_{n}^{pre}$$
is an expected new energy consumption rate in the n-th stage.

7. The method for generating an installed capacity of a power system according to claim 4, wherein the determining, based on the initial installed capacity, the installed capacity label corresponding to the upper limit of the one-time investment coefficient and the lower limit of the new energy consumption rate for each stage of the training power system by using the wave search algorithm comprises:
normalizing a maximum total cost and a maximum new energy consumption rate corresponding to the installed capacity optimal solution set to obtain a total cost baseline value and a new energy consumption rate baseline value;
solving a reduction process objective function according to the total cost baseline value and the new energy consumption rate baseline value to obtain a reduction process baseline objective value, wherein the reduction process objective function is Loss=δ^{ƒ}ƒ^{a}+δ^{g}g^{a}; Loss is the reduction process baseline objective value; ƒ^{a} is the total cost baseline value; g^{a} is the new energy consumption rate baseline value; δ^{ƒ} is a weight of an economic indicator; and δ^{g} is a weight of a consumption rate indicator; and
determining the installed capacity label corresponding to the upper limit of the one-time investment coefficient and the lower limit of the new energy consumption rate for each stage of the training power system by using the wave search algorithm according to the total cost baseline value, the new energy consumption rate baseline value, and the reduction process baseline objective value.

8. A computer device, comprising a memory, a processor, and a computer program stored in the memory and executable on the processor, wherein the computer program is executed by the processor to implement the method for generating an installed capacity of a power system according to claim 1.

9. A non-transitory computer-readable storage medium, wherein the computer-readable storage medium stores a computer program, and the computer program, when executed by a processor, implements the method for generating an installed capacity of a power system according to claim 1.

10. The computer device according to claim 8, wherein the training the CNN-BiLSTM-BiGRU neural network model using the training dataset comprises:
constructing the training dataset;
inputting the upper limit of the one-time investment coefficient and the lower limit of the new energy consumption rate for each stage of the training power system into a current CNN-BiLSTM-BiGRU neural network model to obtain a predicted value of the installed capacity upper bound and a predicted value of the installed capacity lower bound;
determining a loss function value according to the predicted value of the installed capacity upper bound, the predicted value of the installed capacity lower bound, and the corresponding installed capacity label;
determining whether a training termination condition is satisfied, wherein the training termination condition is that a maximum number of iterations is reached or that the loss function value is less than a preset value;
if the training termination condition is satisfied, terminating training, and using the current CNN-BiLSTM-BiGRU neural network model as the power system installed capacity generation model; or
if the training termination condition is not satisfied, adjusting model parameters of the current CNN-BiLSTM-BiGRU neural network model according to the loss function value, and returning to step of “inputting the upper limit of the one-time investment coefficient and the lower limit of the new energy consumption rate for each stage of the training power system into the current CNN-BiLSTM-BiGRU neural network model to obtain the predicted value of the installed capacity upper bound and the predicted value of the installed capacity lower bound”.

11. The computer device according to claim 8, wherein constructing the training dataset comprises:
generating the upper limit of the one-time investment coefficient and the lower limit of the new energy consumption rate for each stage of the training power system by using a random function;
generating an initial installed capacity of the training power system by using the multi-objective coronavirus disease optimization algorithm; and
determining, based on the initial installed capacity, the installed capacity label corresponding to the upper limit of the one-time investment coefficient and the lower limit of the new energy consumption rate for each stage of the training power system by using the wave search algorithm, to obtain the training dataset.

12. The computer device according to claim 11, wherein the generating the initial installed capacity of the training power system by using the multi-objective coronavirus disease optimization algorithm comprises:
establishing a multi-objective optimization model, wherein the multi-objective optimization model takes minimizing a total coefficient and maximizing the new energy consumption rate as objective functions, and takes unit capacity constraints, unit commitment constraints, and clean low-carbon driving constraints as constraint conditions;
solving the multi-objective optimization model by using the multi-objective coronavirus disease optimization algorithm to determine an installed capacity optimal solution set; and
determining the initial installed capacity of the training power system according to the installed capacity optimal solution set, wherein an upper bound of the initial installed capacity is a maximum power source capacity value in the installed capacity optimal solution set, and a lower bound of the initial installed capacity is a minimum power source capacity value in the installed capacity optimal solution set.

13. The computer device according to claim 12, wherein the objective functions are:
$$\{ \begin{matrix}min {F}^{a} = \frac{1}{{T}_{a}} {\sum }_{∀ k , ∀ n} [ {a}_{n}^{k} ( {P}_{n}^{k} - {P}_{n - 1}^{k} ) + {m}_{n}^{k} {P}_{n}^{k} ] + \\ {\sum }_{∀ n , ∀ s , ∀ t} {τ}_{s} {e}_{n}^{es} ( {p}_{n , s , t}^{es , c} + {p}_{n , s , t}^{es , d} ) Δ t + {\sum }_{∀ n , ∀ s , ∀ t} {τ}_{s} {e}_{n}^{g} {p}_{n , s , t}^{g} Δ t + \\ {\sum }_{∀ n , ∀ s , ∀ t} {τ}_{s} {e}_{n}^{cur} {p}_{n , s , t}^{cur} Δ t \\ min {G}^{a} = - \frac{1}{{N}_{r}} {\sum }_{∀ n} \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )}\end{matrix}$$
wherein F^{a} is a total cost; Tₐ is a number of days in a current stage;
$${a}_{n}^{k}$$
is an investment cost per unit of capacity of power generation equipment in an n-th stage;
$${P}_{n}^{k}$$
is an installed capacity of the power generation equipment in the n-th stage;
$${P}_{n - 1}^{k}$$
is an installed capacity of the power generation equipment in an (n−1)-th stage;
$${m}_{n}^{k}$$
is a maintenance cost per unit of capacity of the power generation equipment in the n-th stage; τₛ is a weight coefficient of an s-th scenario;
$${e}_{n}^{es}$$
is an operating cost per unit of power of electrochemical energy storage equipment in the n-th stage;
$${p}_{n , s , t}^{es , c}$$
is a charging power of the electrochemical energy storage equipment in the n-th stage, s-th scenario, and a t-th time period;
$${p}_{n , s , t}^{es , d}$$
is a discharging power of the electrochemical energy storage equipment in the n-th stage, s-th scenario, and t-th time period; Δt is a time interval;
$${e}_{n}^{g}$$
is an operating cost per unit of electricity of thermal power in the n-th stage;
$${p}_{n , s , t}^{g}$$
is an actual output of thermal power in the n-th stage, s-th scenario, and t-th time period;
$${e}_{n}^{c u r}$$
is a penalty cost per unit of electricity for load shedding;
$${p}_{n , s , t}^{cur}$$
is an actual load shedding in the n-th stage, s-th scenario, and t-th time period; G^{a} is a new energy consumption rate; Nᵣ is the number of stages for power generation capacity decision-making;
$${p}_{n , s , t}^{w}$$
is an actual output of wind power in the n-th stage, s-th scenario, and t-th time period;
$${p}_{n , s , t}^{p}$$
is an actual output of photovoltaic power in the n-th stage, s-th scenario, and t-th time period;
$${P}_{n}^{w}$$
is an installed capacity of wind power in the n-th stage;
$${P}_{n}^{p}$$
is an installed capacity of photovoltaic power in the n-th stage;
$${c}_{n , s , t}^{w}$$
is a predicted capacity factor of wind power in the n-th stage, s-th scenario, and t-th time period; and
$${c}_{n , s , t}^{p}$$
is a predicted capacity factor of photovoltaic power in the n-th stage, s-th scenario, and t-th time period.

14. The computer device according to claim 12, wherein the unit capacity constraints are:
$$\{ \begin{matrix}{B}_{n}^{k} \leq {P}_{n}^{k} \leq {A}_{n}^{k} , ∀ n , ∀ k \\ {P}_{n}^{k} \leq {P}_{n + 1}^{k} , ∀ n \\ {\sum }_{k ∈ \{ w , p , g , es \}} {a}_{n}^{k} ( {P}_{n}^{k} - {P}_{n - 1}^{k} ) \leq {F}_{n}^{pre} , ∀ n\end{matrix}$$
wherein
$${P}_{n}^{k}$$
is an installed capacity of power generation equipment in an n-th stage;
$${P}_{n + 1}^{k}$$
is an installed capacity of the power generation equipment in an (n+1)-th stage;
$${B}_{n}^{k}$$
is a lower limit of the installed capacity in the n-th stage;
$${A}_{n}^{k}$$
is an upper limit of the installed capacity in the n-th stage;
$${a}_{n}^{k}$$
is an investment cost per unit of capacity of the power generation equipment in the n-th stage;
$${P}_{n - 1}^{k}$$
is an installed capacity of the power generation equipment in an (n−1)-th stage; and
$${F}_{n}^{p r e}$$
is an expected upper limit of the one-time investment coefficient in the n-th stage;
the unit commitment constraints comprise wind and photovoltaic power operation constraints, thermal power operation constraints, electrochemical energy storage equipment operation constraints, and spinning reserve capacity constraints;
the wind and photovoltaic power operation constraints are:
$$\{ \begin{matrix}0 \leq {p}_{n , s , t}^{w} \leq {c}_{n , s , t}^{w} {P}_{n}^{w} , ∀ n , ∀ s , ∀ t \\ 0 \leq {p}_{n , s , t}^{p} \leq {c}_{n , s , t}^{p} {P}_{n}^{p} , ∀ n , ∀ s , ∀ t\end{matrix} ;$$
wherein
$${p}_{n , s , t}^{w}$$
is an actual output of wind power in the n-th stage, an s-th scenario, and a t-th time period;
$${P}_{n , s , t}^{p}$$
is an actual output of photovoltaic power in the n-th stage, s-th scenario, and t-th time period;
$${P}_{n}^{w}$$
is an installed capacity of wind power in the n-th stage;
$${P}_{n}^{p}$$
is an installed capacity of photovoltaic power in the n-th stage;
$${c}_{n , s , t}^{w}$$
is a predicted capacity factor of wind power in the n-th stage, s-th scenario, and t-th time period; and
$${c}_{n , s , t}^{p}$$
is a predicted capacity factor of photovoltaic power in the n-th stage, s-th scenario, and t-th time period;
the thermal power operation constraints are:
$$\{ \begin{matrix}{p}_{n , s , t}^{g} - {p}_{n , s , t - 1}^{g} \leq {β}_{up}^{g} {b}_{n , s , t}^{g} , ∀ n , ∀ s , ∀ t \\ {p}_{n , s , t - 1}^{g} - {p}_{n , s , t}^{g} \leq {β}_{down}^{g} {b}_{n , s , t}^{g} , ∀ n , ∀ s , ∀ t \\ {α}_{min}^{g} {b}_{n , s , t}^{g} \leq {p}_{n , s , t}^{g} \leq {α}_{max}^{g} {b}_{n , s , t}^{g} \leq {P}_{n}^{g} , ∀ n , ∀ s , ∀ t \\ {b}_{n , s , t}^{g} = {\sum }_{j = 1}^{{J}^{g}} {u}_{n , s , t , j}^{g} {p}_{n , j}^{g}\end{matrix}$$
wherein
$${p}_{n , s , t}^{g}$$
is an actual output of thermal power in the n-th stage, s-th scenario, and t-th time period;
$${p}_{n , s , t - 1}^{g}$$
is an actual output of thermal power in the n-th stage, s-th scenario, and a (t−1)-th time period;
$${β}_{u p}^{g}$$
is a ramping-up power coefficient of thermal power;
$${b}_{n , s , t}^{g}$$
is a grid-connected capacity of thermal power in the n-th stage, s-th scenario, and t-th time period;
$${β}_{down}^{g}$$
is a ramping-down power coefficient of thermal power;
$${α}_{min}^{g}$$
is a minimum technical output coefficient of thermal power;
$${α}_{max}^{g}$$
is a maximum technical output coefficient of thermal power;
$${P}_{n}^{g}$$
is a total installed capacity of thermal power;
$${P}_{n , j}^{g}$$
is an installed capacity of a j-th thermal power unit in the n-th stage;
$${u}_{n , s , t , j}^{g}$$
is an on/off status of the j-th thermal power unit in the n-th stage, s-th scenario, and t-th time period;
the electrochemical energy storage equipment operation constraints are:
$$\{ \begin{matrix}{p}_{n , s , t}^{s} = {p}_{n , s , t}^{es , d} - {p}_{n , s , t}^{es , c} \\ 0 \leq {p}_{n , s , t}^{es , c} , {p}_{n , s , t}^{es , d} \leq {P}_{n}^{e s} \\ {p}_{n , s , t}^{es , c} \times {p}_{n , s , t}^{es , d} = 0 \\ S o {C}_{n , s , t}^{e s} = S o {C}_{n , s , t - 1}^{e s} + \frac{( {η}_{n}^{es , c} {p}_{n , s , t}^{es , c} - {p}_{n , s , t}^{es , d} / {η}_{n}^{es , td} ) Δ t}{{E}_{n}^{e s}} , ∀ n , ∀ s , ∀ t \\ S o {C}_{min}^{e s} \leq S o {C}_{n , s , t}^{e s} \leq S o {C}_{max}^{e s} \\ S o {C}_{n , s , {t}_{0}}^{e s} = S o {C}_{n , s , {t}_{N}}^{e s}\end{matrix} ;$$
wherein
$${p}_{n , s , t}^{s}$$
is an external equivalent actual output of the electrochemical energy storage equipment in the n-th stage, s-th scenario, and t-th time period;
$${p}_{n , s , t}^{es , d}$$
is a discharging power of the electrochemical energy storage equipment in the n-th stage, s-th scenario, and t-th time period;
$${p}_{n , s , t}^{es , c}$$
is a charging power of the electrochemical energy storage equipment in the n-th stage, s-th scenario, and t-th time period;
$${P}_{n}^{e s}$$
is an installed capacity of the electrochemical energy storage equipment in the n-th stage;
$$S o {C}_{n ,}^{e s}$$
is a state of charge of the electrochemical energy storage equipment in the n-th stage, s-th scenario, and t-th time period;
$$S o {C}_{n , s , t - 1}^{e s}$$
is a state of charge of the electrochemical energy storage equipment in the n-th stage, s-th scenario, and (t−1)-th time period;
$${η}_{n}^{es , c}$$
is charging efficiency of the electrochemical energy storage equipment in the n-th stage;
$${η}_{n}^{es , d}$$
is discharging efficiency of the electrochemical energy storage equipment in the n-th stage;
$${E}_{n}^{e s}$$
is rated energy of the electrochemical energy storage equipment in the n-th stage; Δt is a time interval;
$${SoC}_{min}^{es}$$
is a minimum state of charge;
$${SoC}_{max}^{es}$$
is a maximum state of charge;
$${SoC}_{n , s , {t}_{0}}^{es}$$
is an initial state of charge in the n-th stage and s-th scenario; and
$${SoC}_{n , s , {t}_{N}}^{es}$$
is a state of charge at a final time period in the n-th stage and s-th scenario;
the spinning reserve capacity constraints are:
$$\{ \begin{matrix}min ( {α}_{max}^{g} {b}_{n , s , t}^{g} - {p}_{n , s , t}^{g} , {β}_{up}^{g} {b}_{n , s , t}^{g} ) + {P}_{n}^{es} - {p}_{n , s , t}^{es} \geq \\ {\partial }_{up}^{w} {p}_{n , s , t}^{w} + {\partial }_{up}^{p} {p}_{n , s , t}^{p} + {\partial }_{up}^{load} {p}_{n , s , t}^{load} , ∀ n , ∀ s , ∀ t \\ min ( {p}_{n , s , t}^{g} - {α}_{min}^{g} {b}_{n , s , t}^{g} , {β}_{down}^{g} {b}_{n , s , t}^{g} ) + {P}_{n}^{es} + {p}_{n , s , t}^{es} \geq \\ {\partial }_{do}^{w} {p}_{n , s , t}^{w} + {\partial }_{do}^{p} {p}_{n , s , t}^{p} + {\partial }_{do}^{load} {p}_{n , s , t}^{load} , ∀ n , ∀ s , ∀ t\end{matrix} ;$$
wherein
$${p}_{n , s , t}^{es}$$
is an output power of the electrochemical energy storage equipment in the n-th stage, s-th scenario, and t-th time period;
$${\partial }_{up}^{w}$$
is a positive reserve coefficient for wind power;
$${\partial }_{up}^{p}$$
is a positive reserve coefficient for photovoltaic power;
$${\partial }_{up}^{load}$$
is a positive reserve coefficient for electrical load;
$${p}_{n , s , t}^{load}$$
is a power of electrical load in the n-th stage, s-th scenario, and t-th time period;
$${\partial }_{do}^{w}$$
is a negative reserve coefficient for wind power;
$${\partial }_{do}^{p}$$
is a negative reserve coefficient for photovoltaic power; and
$${\partial }_{do}^{load}$$
is a negative reserve coefficient for electrical load;
the clean low-carbon driving constraints comprise carbon emission limit constraints, new energy generation proportion constraints, and minimum new energy consumption rate constraints;
$$\{ \begin{matrix}{\sum }_{∀ s , ∀ t} {τ}_{s} {δ}_{n}^{g} {p}_{n , s , t}^{g} Δ t \leq {X}_{n}^{co} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} {p}_{n , s , t}^{load}} \geq {X}_{n}^{new} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )} \geq {G}_{n}^{pre}\end{matrix}$$
wherein τₛ is a weight coefficient of the s-th scenario;
$${δ}_{n}^{g}$$
is a carbon emission factor of thermal power in the n-th stage;
$${X}_{n}^{co}$$
is a carbon emission quota in the n-th stage;
$${X}_{n}^{new}$$
is a new energy generation proportion requirement in the n-th stage; and
$${G}_{n}^{pre}$$
is an expected new energy consumption rate in the n-th stage.

15. The computer device according to claim 12, wherein the determining, based on the initial installed capacity, the installed capacity label corresponding to the upper limit of the one-time investment coefficient and the lower limit of the new energy consumption rate for each stage of the training power system by using the wave search algorithm comprises:
normalizing a maximum total cost and a maximum new energy consumption rate corresponding to the installed capacity optimal solution set to obtain a total cost baseline value and a new energy consumption rate baseline value;
solving a reduction process objective function according to the total cost baseline value and the new energy consumption rate baseline value to obtain a reduction process baseline objective value, wherein the reduction process objective function is Loss=δ^{ƒ}ƒ^{a}+δ^{g} g^{a}; Loss is the reduction process baseline objective value; ƒ^{a} is the total cost baseline value; g^{a} is the new energy consumption rate baseline value; δ^{ƒ} is a weight of an economic indicator; and δ^{g} is a weight of a consumption rate indicator; and
determining the installed capacity label corresponding to the upper limit of the one-time investment coefficient and the lower limit of the new energy consumption rate for each stage of the training power system by using the wave search algorithm according to the total cost baseline value, the new energy consumption rate baseline value, and the reduction process baseline objective value.

16. The non-transitory computer-readable storage medium according to claim 9, wherein the training the CNN-BiLSTM-BiGRU neural network model using the training dataset comprises:
constructing the training dataset;
inputting the upper limit of the one-time investment coefficient and the lower limit of the new energy consumption rate for each stage of the training power system into a current CNN-BiLSTM-BiGRU neural network model to obtain a predicted value of the installed capacity upper bound and a predicted value of the installed capacity lower bound;
determining a loss function value according to the predicted value of the installed capacity upper bound, the predicted value of the installed capacity lower bound, and the corresponding installed capacity label;
determining whether a training termination condition is satisfied, wherein the training termination condition is that a maximum number of iterations is reached or that the loss function value is less than a preset value;
if the training termination condition is satisfied, terminating the training, and using the current CNN-BiLSTM-BiGRU neural network model as the power system installed capacity generation model; or
if the training termination condition is not satisfied, adjusting model parameters of the current CNN-BiLSTM-BiGRU neural network model according to the loss function value, and returning to step of “inputting the upper limit of the one-time investment coefficient and the lower limit of the new energy consumption rate for each stage of the training power system into the current CNN-BiLSTM-BiGRU neural network model to obtain the predicted value of the installed capacity upper bound and the predicted value of the installed capacity lower bound”.

17. The non-transitory computer-readable storage medium according to claim 9, wherein constructing the training dataset comprises:
generating the upper limit of the one-time investment coefficient and the lower limit of the new energy consumption rate for each stage of the training power system by using a random function;
generating an initial installed capacity of the training power system by using the multi-objective coronavirus disease optimization algorithm; and
determining, based on the initial installed capacity, the installed capacity label corresponding to the upper limit of the one-time investment coefficient and the lower limit of the new energy consumption rate for each stage of the training power system by using the wave search algorithm, to obtain the training dataset.

18. The non-transitory computer-readable storage medium according to claim 17, wherein the generating the initial installed capacity of the training power system by using the multi-objective coronavirus disease optimization algorithm comprises:
establishing a multi-objective optimization model, wherein the multi-objective optimization model takes minimizing a total coefficient and maximizing the new energy consumption rate as objective functions, and takes unit capacity constraints, unit commitment constraints, and clean low-carbon driving constraints as constraint conditions;
solving the multi-objective optimization model by using the multi-objective coronavirus disease optimization algorithm to determine an installed capacity optimal solution set; and
determining the initial installed capacity of the training power system according to the installed capacity optimal solution set, wherein an upper bound of the initial installed capacity is a maximum power source capacity value in the installed capacity optimal solution set, and a lower bound of the initial installed capacity is a minimum power source capacity value in the installed capacity optimal solution set.

19. The non-transitory computer-readable storage medium according to claim 18, wherein the objective functions are:
$$\{ \begin{matrix}min {F}^{a} = \frac{1}{{T}_{a}} {\sum }_{∀ k , ∀ n} [ {a}_{n}^{k} ( {P}_{n}^{k} - {P}_{n - 1}^{k} ) + {m}_{n}^{k} {P}_{n}^{k} ] \\ + {\sum }_{∀ n , ∀ s , ∀ t} {τ}_{s} {e}_{n}^{es} ( {p}_{n , s , t}^{es , c} + {p}_{n , s , t}^{es , d} ) Δ t + {\sum }_{∀ n , ∀ s , ∀ t} {τ}_{s} {e}_{n}^{g} {p}_{n , s , t}^{g} Δ t \\ + {\sum }_{∀ n , ∀ s , ∀ t} {τ}_{s} {e}_{n}^{cur} {p}_{n , s , t}^{cur} Δ t \\ min {G}^{a} = - \frac{1}{N} {\sum }_{∀ n} \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )}\end{matrix}$$
wherein F^{a} is a total cost; Tₐ is a number of days in a current stage;
$${a}_{n}^{k}$$
is an investment cost per unit of capacity of power generation equipment in an n-th stage;
$${P}_{n}^{k}$$
is an installed capacity of the power generation equipment in the n-th stage;
$${P}_{n - 1}^{k}$$
is an installed capacity of the power generation equipment in an (n−1)-th stage;
$${m}_{n}^{k}$$
is a maintenance cost per unit of capacity of the power generation equipment in the n-th stage; τₛ is a weight coefficient of an s-th scenario;
$${e}_{n}^{es}$$
is an operating cost per unit of power of electrochemical energy storage equipment in the n-th stage;
$${p}_{n , s , t}^{es , c}$$
is a charging power of the electrochemical energy storage equipment in the n-th stage, s-th scenario, and a t-th time period;
$${p}_{n , s , t}^{es , d}$$
is a discharging power of the electrochemical energy storage equipment in the n-th stage, s-th scenario, and t-th time period; Δt is a time interval;
$${e}_{n}^{g}$$
is an operating cost per unit of electricity of thermal power in the n-th stage;
$${p}_{n , s , t}^{g}$$
is an actual output of thermal power in the n-th stage, s-th scenario, and t-th time period;
$${e}_{n}^{cur}$$
is a penalty cost per unit of electricity for load shedding;
$${p}_{n , s , t}^{cur}$$
is an actual load shedding in the n-th stage, s-th scenario, and t-th time period; G^{a} is a new energy consumption rate; Nᵣ is the number of stages for power generation capacity decision-making;
$${p}_{n , s , t}^{w}$$
is an actual output of wind power in the n-th stage, s-th scenario, and t-th time period;
$${p}_{n , s , t}^{p}$$
is an actual output of photovoltaic power in the n-th stage, s-th scenario, and t-th time period;
$${P}_{n}^{w}$$
is an installed capacity of wind power in the n-th stage;
$${P}_{n}^{p}$$
is an installed capacity of photovoltaic power in the n-th stage;
$${c}_{n , s , t}^{w}$$
is a predicted capacity factor of wind power in the n-th stage, s-th scenario, and t-th time period; and
$${c}_{n , s , t}^{p}$$
is a predicted capacity factor of photovoltaic power in the n-th stage, s-th scenario, and t-th time period.

20. The non-transitory computer-readable storage medium according to claim 18, wherein the unit capacity constraints are:
$$\{ \begin{matrix}{B}_{n}^{k} \leq {P}_{n}^{k} \leq {A}_{n}^{k} , ∀ n , ∀ k \\ {P}_{n}^{k} \leq {P}_{n + 1}^{k} , ∀ n \\ {\sum }_{k ∈ \{ w , p , g , es \}} {a}_{n}^{k} ( {P}_{n}^{k} - {P}_{n - 1}^{k} ) \leq {F}_{n}^{p r e} , ∀ n\end{matrix}$$
wherein
$${P}_{n}^{k}$$
is an installed capacity of power generation equipment in an n-th stage;
$${P}_{n + 1}^{k}$$
is an installed capacity of the power generation equipment in an (n+1)-th stage;
$${B}_{n}^{k}$$
is a lower limit of the installed capacity in the n-th stage;
$${A}_{n}^{k}$$
is an upper limit of the installed capacity in the n-th stage;
$${a}_{n}^{k}$$
is an investment cost per unit of capacity of the power generation equipment in the n-th stage;
$${P}_{n - 1}^{k}$$
is an installed capacity of the power generation equipment in an (n−1)-th stage; and
$${F}_{n}^{p r e}$$
is an expected upper limit of the one-time investment coefficient in the n-th stage;
the unit commitment constraints comprise wind and photovoltaic power operation constraints, thermal power operation constraints, electrochemical energy storage equipment operation constraints, and spinning reserve capacity constraints;
the wind and photovoltaic power operation constraints are:
$$\{ \begin{matrix}0 \leq {p}_{n , s , t}^{w} \leq {c}_{n , s , t}^{w} {P}_{n}^{w} , ∀ n , ∀ s , ∀ t \\ 0 \leq {p}_{n , s , t}^{p} \leq {c}_{n , s , t}^{p} {P}_{n}^{p} , ∀ n , ∀ s , ∀ t\end{matrix} ;$$
wherein
$${p}_{n , s , t}^{w}$$
is an actual output of wind power in the n-th stage, an s-th scenario, and a t-th time period;
$${p}_{n , s , t}^{p}$$
is an actual output of photovoltaic power in the n-th stage, s-th scenario, and t-th time period;
$${P}_{n}^{w}$$
is an installed capacity of wind power in the n-th stage;
$${P}_{n}^{p}$$
is an installed capacity of photovoltaic power in the n-th stage;
$${c}_{n , s , t}^{w}$$
is a predicted capacity factor of wind power in the n-th stage, s-th scenario, and t-th time period; and
$${c}_{n , s , t}^{p}$$
is a predicted capacity factor of photovoltaic power in the n-th stage, s-th scenario, and t-th time period;
the thermal power operation constraints are:
$$\{ \begin{matrix}{p}_{n , s , t}^{g} - {p}_{n , s , t - 1}^{g} \leq {β}_{up}^{g} {b}_{n , s , t}^{g} , ∀ n , ∀ s , ∀ t \\ {p}_{n , s , t - 1}^{g} - {p}_{n , s , t}^{g} \leq {β}_{down}^{g} {b}_{n , s , t}^{g} , ∀ n , ∀ s , ∀ t \\ {α}_{min}^{g} {b}_{n , s , t}^{g} \leq {p}_{n , s , t}^{g} \leq {α}_{max}^{g} {b}_{n , s , t}^{g} \leq {P}_{n}^{g} , ∀ n , ∀ s , ∀ t \\ {b}_{n , s , t}^{g} = {\sum }_{j = 1}^{{J}^{g}} {u}_{n , s , t , j}^{g} {P}_{n , j}^{g}\end{matrix}$$
wherein
$${p}_{n , s , t}^{g}$$
is an actual output of thermal power in the n-th stage, s-th scenario, and t-th time period;
$${p}_{n , s , t - 1}^{g}$$
is an actual output of thermal power in the n-th stage, s-th scenario, and a (t−1)-th time period;
$${β}_{u p}^{g}$$
is a ramping-up power coefficient of thermal power;
$${b}_{n , s , t}^{g}$$
is a grid-connected capacity of thermal power in the n-th stage, s-th scenario, and t-th time period;
$${β}_{d o w n}^{g}$$
is a ramping-down power coefficient of thermal power;
$${α}_{min}^{g}$$
is a minimum technical output coefficient of thermal power;
$${α}_{max}^{g}$$
is a maximum technical output coefficient of thermal power;
$${P}_{n}^{g}$$
is a total installed capacity of thermal power;
$${P}_{n , j}^{g}$$
is an installed capacity of a j-th thermal power unit in the n-th stage;
$${u}_{n , s , t , j}^{g}$$
is an on/off status of the j-th thermal power unit in the n-th stage, s-th scenario, and t-th time period;
the electrochemical energy storage equipment operation constraints are:
$$\{ \begin{matrix}{p}_{n , s , t}^{s} = {p}_{n , s , t}^{es , d} - {p}_{n , s , t}^{es , c} \\ 0 \leq {p}_{n , s , t}^{es , c} , {p}_{n , , s , t}^{es , d} \leq {P}_{n}^{e s} \\ {p}_{n , s , t}^{es , c} \times {p}_{n , s , t}^{es , d} = 0 \\ So {C}_{n , s , t}^{e s} = S o {C}_{n , s , t - 1}^{e s} + \frac{( {η}_{n}^{es , c} {p}_{n , s , t}^{es , c} - {p}_{n , s , t}^{es , d} / {η}_{n}^{es , d} ) Δ C}{{E}_{n}^{e s}} , ∀ n , ∀ s , ∀ t \\ So {C}_{min}^{e s} \leq S o {C}_{n , s , t}^{e s} \leq S o {C}_{max}^{e s} \\ So {C}_{n , s , {t}_{0}}^{e s} = S o {C}_{n , s , {t}_{N}}^{e s}\end{matrix} ;$$
wherein
$${p}_{n , s , t}^{s}$$
is an external equivalent actual output of the electrochemical energy storage equipment in the n-th stage, s-th scenario, and t-th time period;
$${p}_{n , s , t}^{es , d}$$
is a discharging power of the electrochemical energy storage equipment in the n-th stage, s-th scenario, and t-th time period;
$${p}_{n , s , t}^{es , c}$$
is a charging power of the electrochemical energy storage equipment in the n-th stage, s-th scenario, and t-th time period;
$${P}_{n}^{e s}$$
is an installed capacity of the electrochemical energy storage equipment in the n-th stage;
$$S o {C}_{n , s , t}^{e s}$$
is a state of charge of the electrochemical energy storage equipment in the n-th stage, s-th scenario, and t-th time period;
$$S o {C}_{n , s , t - 1}^{e s}$$
is a state of charge of the electrochemical energy storage equipment in the n-th stage, s-th scenario, and (t−1)-th time period;
$${η}_{n}^{es , c}$$
is charging efficiency of the electrochemical energy storage equipment in the n-th stage;
$${η}_{n}^{es , d}$$
is discharging efficiency of the electrochemical energy storage equipment in the n-th stage;
$${E}_{n}^{e s}$$
is rated energy of the electrochemical energy storage equipment in the n-th stage; Δt is a time interval;
$$S o {C}_{min}^{e s}$$
is a minimum state of charge;
$$S o {C}_{max}^{e s}$$
is a maximum state of charge;
$$S o {C}_{n , s , {t}_{0}}^{e s}$$
is an initial state of charge in the n-th stage and s-th scenario; and
$${SoC}_{n , s , {t}_{N}}^{es}$$
is a state of charge at a final time period in the n-th stage and s-th scenario;
the spinning reserve capacity constraints are:
$$\{ \begin{matrix}min ( {α}_{max}^{g} {b}_{n , s , t}^{g} - {p}_{n , s , t}^{g} , {β}_{up}^{g} {b}_{n , s , t}^{g} ) + {P}_{n}^{es} - {p}_{n , s , t}^{g} \geq \\ {\partial }_{up}^{w} {p}_{n , s , t}^{w} + {\partial }_{up}^{p} {p}_{n , s , t}^{p} + {\partial }_{up}^{load} {p}_{n , s , t}^{load} , ∀ n , ∀ s , ∀ t \\ min ( {p}_{n , s , t}^{g} - {α}_{min}^{g} {b}_{n , s , t}^{g} , {β}_{down}^{g} {b}_{n , s , t}^{g} ) + {P}_{n}^{es} + {p}_{n , s , t}^{g} \geq \\ {\partial }_{do}^{w} {p}_{n , s , t}^{w} + {\partial }_{do}^{p} {p}_{n , s , t}^{p} + {\partial }_{do}^{load} {p}_{n , s , t}^{load} , ∀ n , ∀ s , ∀ t\end{matrix} \text{} ;$$
wherein
$${p}_{n , s , t}^{e s}$$
is an output power of the electrochemical energy storage equipment in the n-th stage, s-th scenario, and t-th time period;
$${\partial }_{u p}^{w}$$
is a positive reserve coefficient for wind power;
$${\partial }_{u p}^{p}$$
is a positive reserve coefficient for photovoltaic power;
$${\partial }_{u p}^{l o a d}$$
is a positive reserve coefficient for electrical load;
$${p}_{n , s , t}^{l o a d}$$
is a power of electrical load in the n-th stage, s-th scenario, and t-th time period;
$${\partial }_{d o}^{w}$$
is a negative reserve coefficient for wind power;
$${\partial }_{d o}^{p}$$
is a negative reserve coefficient for photovoltaic power; and
$${\partial }_{d o}^{l o a d}$$
is a negative reserve coefficient for electrical load;
the clean low-carbon driving constraints comprise carbon emission limit constraints, new energy generation proportion constraints, and minimum new energy consumption rate constraints;
$$\{ \begin{matrix}{\sum }_{∀ s , ∀ t} {τ}_{s} {δ}_{n}^{g} {p}_{n , s , t}^{w} Δ t \leq {X}_{n}^{co} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} {p}_{n , s , t}^{load}} \geq {X}_{n}^{new} \\ \frac{{\sum }_{∀ s , ∀ t} {τ}_{s} ( {p}_{n , s , t}^{w} + {p}_{n , s , t}^{p} )}{{\sum }_{∀ s , ∀ t} {τ}_{s} ( {c}_{n , s , t}^{w} {P}_{n}^{w} + {c}_{n , s , t}^{p} {P}_{n}^{p} )} \geq {G}_{n}^{pre}\end{matrix} \text{}$$
wherein τₛ is a weight coefficient of the s-th scenario;
$${δ}_{n}^{g}$$
is a carbon emission factor of thermal power in the n-th stage;
$${X}_{n}^{c o}$$
is a carbon emission quota in the n-th stage;
$${X}_{n}^{n e w}$$
is a new energy generation proportion requirement in the n-th stage; and
$${G}_{n}^{p r e}$$
is an expected new energy consumption rate in the n-th stage.
